(19) United States
(12) Patent Application Publication
(10) Pub. No.: US 2024/0383678 A1
(43) Pub. Date: Nov. 21, 2024

(54) Automated Parcel Buffering System

(71) Applicant: Box Bot Inc., Oakland, CA (US)

(72) Inventors: Austin OEHLERKING, Oakland, CA (US); John MCDONALD, Oakland, CA (US); Allyson Francis, San Francisco, CA (US); Joshua TERRELL, Oakland, CA (US); Dhruv RATURI, Oakland, CA (US); Abhignan TEKAKAPALLI, Oakland, CA (US); Joseph RAPALA, Oakland, CA (US)

(21) Appl. No.: 18/687,284

(22) PCT Filed: Jul. 25, 2022
(86) PCT No.: PCT/US2022/074119

§ 371 Date: Feb. 27, 2024

Related U.S. Application Data
(60) Provisional application No. 63/225,448, filed on Jul. 24, 2021.

(51) Int. Cl. B65G 1/04; B65G 1/06; B65G 1/137; B65G 13/02

(52) U.S. Cl. CPC B65G 1/0435; B65G 1/06; B65G 1/1378; B65G 13/02; B65G 2203/044

(57) ABSTRACT

Disclosed is an automated parcel buffer (APB) (100) which may be implemented using modular components which may include an end of arm tool (EOAT) (302) facilitating tray containerization, movable within a storage module. The EOAT (302) is moveably attached to a two-dimensional (2D) gantry (300). A plurality of friction rollers (700) and drive are configured to selectively engage and disengage from one or more package support trays to support and move packages within a storage module shelving areas (308) and central corridor (306). Multiple storage modules (1602, 1604, 1606) may be interconnected to form a storage matrix (1600) with material handling conveyors (1620, 1622, 1624) facilitating automated loading and unloading of the matrix.

### CROSS-REFERENCE TO RELATED APPLICATIONS

The application claims priority under 35 U.S.C. § 119 (e) to U.S. Provisional Patent Application No. 63/225,448, titled “END OF ARM TOOL, TRAY, AND SHEL VING SYSTEM FOR AUTOMATED PARCEL BUFFERING,” filed on Jul. 24, 2021, which is herein incorporated by reference in its entirety.

### BACKGROUND

### 1. Field

The present relates in general to the automated storage and retrieval of objects such as parcels and, more particularly, to automated parcel buffering (APB) arrangements including an end-of-arm tool (EOAT) and tray adapted for parcel containerization.

### 2. Related Art

With the continued growth of Internet-based commerce, parcel delivery has become an increasingly prevalent and important means of conveying goods to businesses and individuals alike. However, growing parcel volumes present challenges for parcel transporters. Shippers become increasingly reliant on parcel shipping as a mode of product distribution. Parcel recipients may have to deal with increasing parcel volume, as well as increased instances of returning parcels via return shipment. Meanwhile, “last mile” delivery logistics are commonly understood to represent a significant portion of the cost and burden of parcel transport. Transitioning of parcels between regional or wide area shipment and local delivery may present substantial challenges with parcel storage, organization and conveyance between transporters.

For these and other reasons, parcel shippers, carriers and recipients alike may benefit greatly from opportunities to facilitate efficient parcel storage, reduce the cost of delivery, increase the speed and efficiency of delivery, and/or provide parcel shipping participants with greater convenience and flexibility.

### SUMMARY

Disclosed is a system for temporary storage and sorting of parcels in parcel delivery operations, including various components, subsystems, methods and processes for implementing various portions of such operations. Embodiments may be highly automated, with options to minimize or eliminate the amount of human activity required for typical operations. In some embodiments, systems may be highly modular and scalable, to facilitate flexible adaptation of capacity and configuration based on parameters such as desired buffer size, rate, and parcel requirements. Some embodiments may utilize a high-density configuration for space efficiency. Embodiments may be seamlessly integrated with other automated or manual systems for parcel sorting and transport.

For example, in accordance with one aspect of the disclosure, an Automated Parcel Buffering (APB) system (sometimes also referred to as a package receiving, storing, and retrieving (PRSR) system) is disclosed. Generally, some embodiments of the APB may be used to securely store, sort, sequence, merge, consolidate, and optimize delivery routes for items such as packages, parcels, mail, prepared food, groceries, or other items that may be e.g. placed in a tray.

The APB includes one or more storage modules, each sometimes referred to as a pickup and receiving stations (PRS). In one example, the PRS includes a plurality of shelves arranged as a first two-dimensional (2D) shelving matrix along and adjacent to a central corridor and a second 2D shelving matrix along and adjacent to a side of the central corridor opposite the first 2D shelving matrix, a 2D gantry oriented along the central corridor and adjacent to the first and second 2D shelving matrices, an end-of-arm tool (EOAT) supported by the 2D gantry, a first access portal for receiving a package from outside of the PRS via conveyor, and a second access portal for ejecting a package from the PRS onto an output conveyor.

Each shelf of the 2D shelving matrices is configured for engagement and support of the package tray to store the package tray. The EOAT selectively engaging and disengaging from a package tray, and moving the package tray between a central position, a first offset position extended in a first direction that is perpendicular to the 2D gantry, and a second offset position extended in a second direction that is perpendicular to the 2D gantry and is in an opposite direction to the first direction. The first access portal positioned proximate the 2D gantry such that the EOAT can extend the package tray towards the first access portal for placement of the package on the package tray and the second access portal positioned proximate the 2D gantry such that the EOAT can eject the package into the second access portal.

In another example, the PRS includes a first plurality of shelves and a second plurality of shelves, where the second plurality of shelves is located opposite the first plurality of shelves along a central corridor, and a 2D gantry oriented along the central corridor between the first plurality of shelves and the second plurality of shelves. The PRS also includes an EOAT device supported by the 2D gantry, an access portal for receiving one or more packages from outside of the PRS, and internal shelving rails within the PRS and on the one or more sides of the central corridor. The EOAT device is configured to selectively engage and disengage from one or more package support trays, and move the one or more package support trays between a central position, a position extended in a first direction perpendicularly to the 2D gantry, and a position extended in a second, opposite direction perpendicularly to the 2D gantry. A tray with or without an associated package may be moved by the EOAT and gantry to or from input/output portals and storage shelving locations within a storage module.

The PRS further includes one or more access portals for receiving or dispensing one or more packages from outside of the PRS. The access portal may be positioned proximate the 2D gantry such that the EOAT device may extend one of the trays towards the portal for placement of a package thereon, and internal shelving rails within the PRS and on the one or more sides of the central corridor, adapted for engagement and support of the one or more package support trays for storing supported thereon.

In some embodiments, an access portal may allow individuals, such as a human operator, to dispense one or more packages into the APB. There may be a computer interface for, e.g., authenticating an individual interacting with the APB and/or identifying a package or sequence of packages being retrieved from or dispensed into the APB. The portal may be positioned proximate to the gantry, such that the EOAT carrying an empty tray may be positioned to receive a package onto that tray. A tray and associated package may be moved by the EOAT and gantry from the portal to storage shelving within the APB, and/or to another access portal.

Also disclosed is an improved EOAT device that may be beneficially utilized in embodiments of an APB described herein. The EOAT comprises a mounting point configured to be moveably attached to a 2D gantry, a linear actuator physically attached to the mounting point, a plate physically attached to the mounting point, a plurality of friction rollers physically attached to the plate, and a plurality of drive wheels physically attached to the plate. The plurality of friction rollers is configured to selectively engage and disengage from one or more package support trays configured to support a package and the linear actuator is configured to move the one or more package support trays between a central position, a position extended in a first direction perpendicularly to the 2D gantry, and a position extended in a second, opposite direction perpendicularly to the 2D gantry. The one or more support trays are punctuated with cutouts that allow passage of the plurality of drive wheels. The plurality of drive wheels are configured to either rise or lower through the cutouts, physically contact a bottom surface of the package when the plurality of drive wheels are raised, move the package on a portion of the one or more support trays onto or off the one or more support trays, and also positioning the package onto a desired position on the one or more support trays, when the plurality of wheels are turning, and allow the package to rest on a top surface of the one or more support trays when the plurality of drive wheels are lowered. Thus, the drive wheels, when driven, operate to position a package at a particular location or section of the tray (“containerization”) as well as discharging the package from the EOAT to an output portal or channel (“de-containerization”).

In some APB embodiments, two or more PRS storage modules may be interconnected into a storage matrix. An input conveyor system may provide for transport of parcels between individual storage modules, e.g. conveying parcels to and from each PRS access portal. The access portals of the PRS may be located along a centerline along the central corridor between the first plurality of shelves and the second plurality of shelves that is parallel to the 2D gantry. An internal conveyor may be provided through the length of a PRS module, in order to maximize parcel throughput and EOAT utilization. Such arrangements may be utilized to implement a matrix of storage modules/PRS, which may provide a high-capacity APB solution.

As an example, disclosed is an automated parcel handling system. The automated parcel handling system comprises a plurality of storage modules, each storage module comprising a central corridor extending along a length of the module, a 2D gantry oriented along the central corridor, an EOAT supported by the 2D gantry, shelving matrices on each side of, and adjacent to, the central corridor, an intake access portal for receiving a package from outside of the PRS, an outlet access portal for removing a package from the PRS, a plurality of conveyors interconnecting the plurality of storage modules access portals. The EOAT selectively engaging and disengaging from a package tray, and moving the package tray between: a central position within the central corridor, a first offset position extended in a first direction that is perpendicular to the 2D gantry, and a second offset position extended in a second direction that is perpendicular to the 2D gantry and is in an opposite direction to the first direction. Each shelving matrix comprises a plurality of shelving rail pairs into which a tray can be inserted or removed by the EOAT. The intake access portal positioned proximate the 2D gantry such that the EOAT extends the package tray towards the intake access portal for placement of the package on the package tray and the outlet access portal positioned proximate the 2D gantry such that the EOAT can eject the package into the outlet access portal.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIGS. 1A-B are right and left perspective views of an Automated Parcel Buffer (APB) with two input/output portals in accordance with the present disclosure.

FIG. 2 is a close-up perspective view of a portal for package insertion into or retrieval from the APB shown in FIGS. 1A-B, in accordance with the present disclosure.

FIG. 3 is a top plan view of the APB shown in FIGS. 1A-2, in accordance with the present disclosure.

FIG. 4 is a side elevation of the APB shown in FIGS. 1A-3, in accordance with the present disclosure.

FIG. 5 is a system block diagram of an example of an implementation of the APB, shown in FIGS. 1A-4, in accordance with the present disclosure.

FIG. 6 is a system block diagram of another example of an implementation of an APB, in accordance with the present disclosure.

FIG. 7 is a perspective view of an example of an implementation of an end-of-arm tool (EOAT) with package in accordance with the present disclosure.

FIGS. 8A, 8B, 8C and 8D are progressive side views of an EOAT motion sequence used to load and unload a tray from a shelf or portal in accordance with the present disclosure.

FIG. 9 is a detailed side view of the EOAT in accordance with the present disclosure.

FIG. 10 is a perspective view of the EOAT without tray or box in accordance with the present disclosure.

FIG. 11 is a detailed perspective view of an example of an implementation of a tray grabber on an EOAT in accordance with the present disclosure.

FIG. 12 is a perspective view of the tray with package in accordance with the present disclosure.

FIG. 13A is a perspective front view of another example of an implementation of the EOAT loaded with an empty removable tray having cutouts in accordance with the present disclosure.

FIG. 13B a perspective front view of an operational mode of the embodiment of FIG. 13A, where the drive wheels are raised into the tray's cutouts in accordance with the present disclosure.

FIG. 13C is a top plan view of an example of an implementation of a tray showing one possible arrangement of the cutouts in accordance with the present disclosure.

FIG. 13D is a sectional cut view A-A of the tray of FIG. 13C showing a staggering of the package drive wheels in accordance with the present disclosure.

FIGS. 14A, 14B, 14C, 14D, 14E, and 14F are progressive side views of another example of an implementation of the EOAT motion sequence used to containerize and de-containerize packages from the portal in accordance with the present disclosure.

FIG. 15A is a system block diagram of an APB storage module with end portals. FIG. 15B is a perspective view of a storage module with end portals.

FIG. 16A is a system block diagram of an example of an implementation of a matrix of storage modules in accordance with the present disclosure.

FIG. 16B is a top plan view of an APB implementing a matrix of storage modules, in accordance with another embodiment.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

In particular, a number of different systems and components are described which may be beneficially used, alone or in various combinations, for implementation of a parcel buffering, i.e. parcel storage and retrieval, system. In some embodiments, such systems may be implemented in a highly automated, and highly space-efficient manner, while also providing substantial flexibility with respect to parcel sizing and containerization.

An APB may sometimes be described herein as a combination of different subsystems working together. In some embodiments, a tree analogy may be utilized, with an EOAT for parcel handling referred to as a “stem”, an individual storage module or PRS referred to as a “tree”, and a set of interconnected trees or storage modules referred to as a “forest”. While some aspects of the disclosure herein may be described in isolation, while others may be described in the context of an interconnected system, it is contemplated and understood that in various embodiments, aspects of the disclosure may be combined in different manners with different subsystems, and/or operated independently from one another.

While certain embodiments and illustrations described herein refer to handling of parcels and/or packages (which terms may be used interchangeably), it is contemplated and understood that various embodiments and inventions described herein may be beneficially utilized in connection with a wide variety of items, particularly items that may be placed in standardized trays or containers for handling. Examples include, without limitation: mail, parcels, packages, prepared foods, groceries, or other items that may be placed in trays or containers. Systems and methods referenced herein as handling parcels or packages should not be deemed limited to handling of such items, unless exclusion of other item types is expressly stated or inherent given the nature of the described method or apparatus.

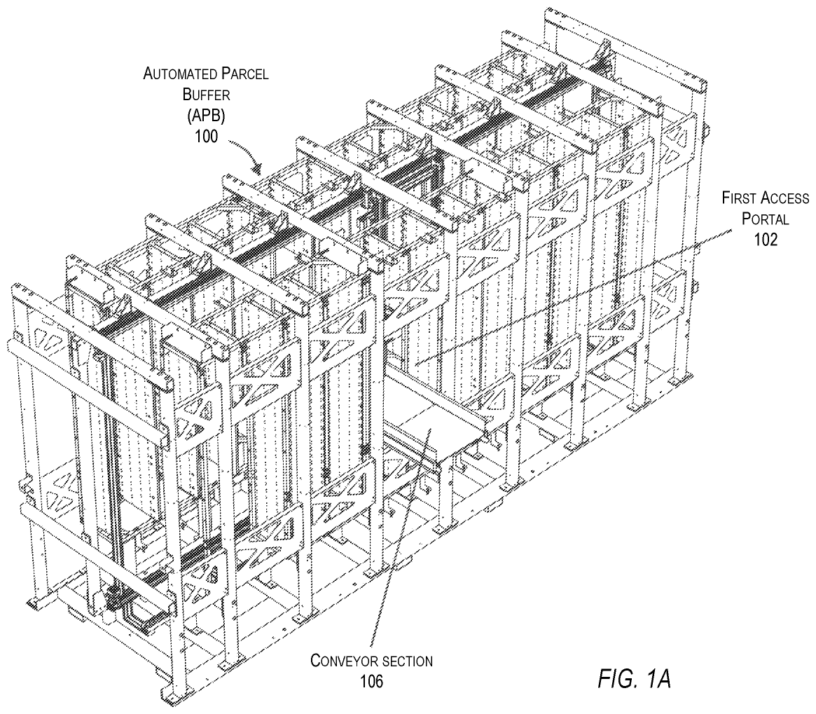

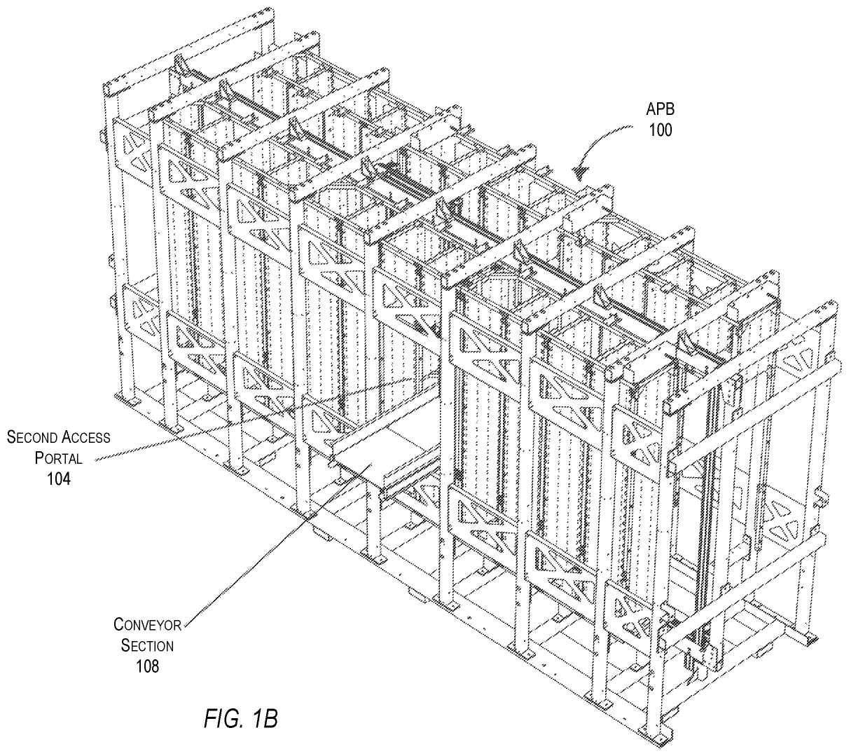

FIG. 1A is a right perspective view of an example of an implementation of an APB 100 comprised of a single storage module, with a first access portal 102 shown in accordance with the present disclosure. In FIG. 1B, a left perspective view of the APB 100 with a second access portal 104 is shown. In this example, to optimize use of a floor space, the APB 100 is constructed having a width footprint that is approximately three times the width dimension of the tray, such that the tray may be stored in stationary shelving on either side of a central aisle or corridor, as well as permitting travel of the tray in the aisle by means of a gantry and EOAT, as described further hereinbelow.

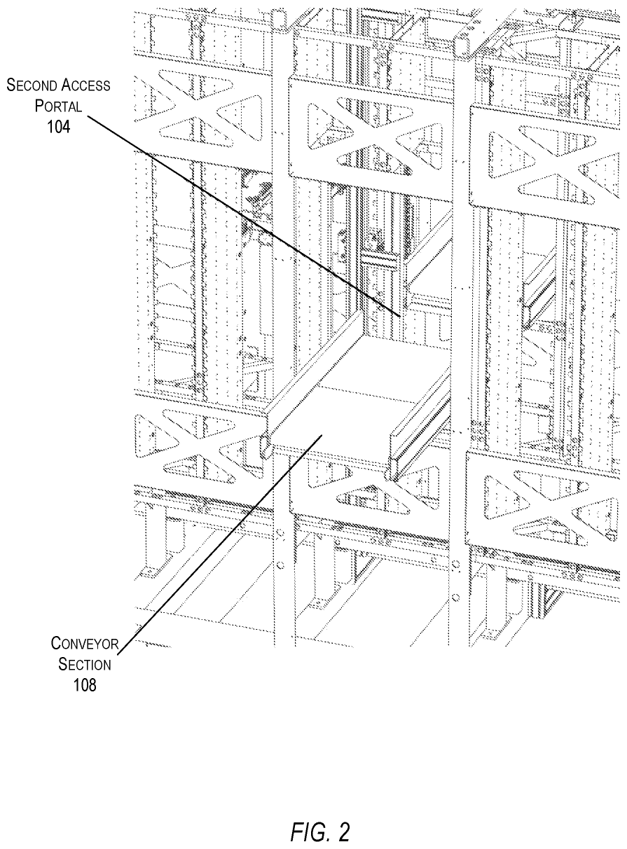

In FIG. 2, a close-up perspective view of the second access portal 104 is shown. In this example, the first access portal 102 and second access portal 104 (generally referred to herein as “portals”) are preferably set into the stationary shelving of APB 100 and include a segment of a powered (driven) portal conveyor (e.g., first access portal 102 includes a first portal conveyor section 106 extending through it and the second access portal 104 includes a second portal conveyor section 108 extending through it). As will be further described, the portals (either the first access portal 102 or the second access portal 104) provide a mechanism for external automated material handling systems, such as a system of transport conveyors, or individuals, such as human operators, to load packages into, and/or remove packages from, APB 100. The portals may also be used to load trays into, and/or remove trays from, APB 100, with or without associated packages.

Generally, a computer system and a computer interface (not shown) are used to enable an individual (or a separate package handling subsystem) to interact with the APB 100. As an example, a human operator may utilize the computer interface to identify a package entering into the APB 100 via the first access portal 102 (such as by scanning a barcode associated with a package or photographing the package using a camera integrated with the computer system). This computer system may be configured to identify several packages prior to them sequentially entering the APB 100 by manual loading (e.g., deposit by human operator) or by transport to the first portal conveyor section 106 via external automated material handling equipment. Additionally, or alternatively, a human operator may utilize the computer interface of the computer system to specify a package or several packages to be retrieved from within APB 100 and presented at first access portal 102 for removal by the requesting individual or by external automated material handling equipment, such as a system of transport conveyors which may interface with the first portal conveyor section 106. In some embodiments, such a computer interface may be provided proximate to one or more of portals (e.g., first access portal 102 and second access portal 104).

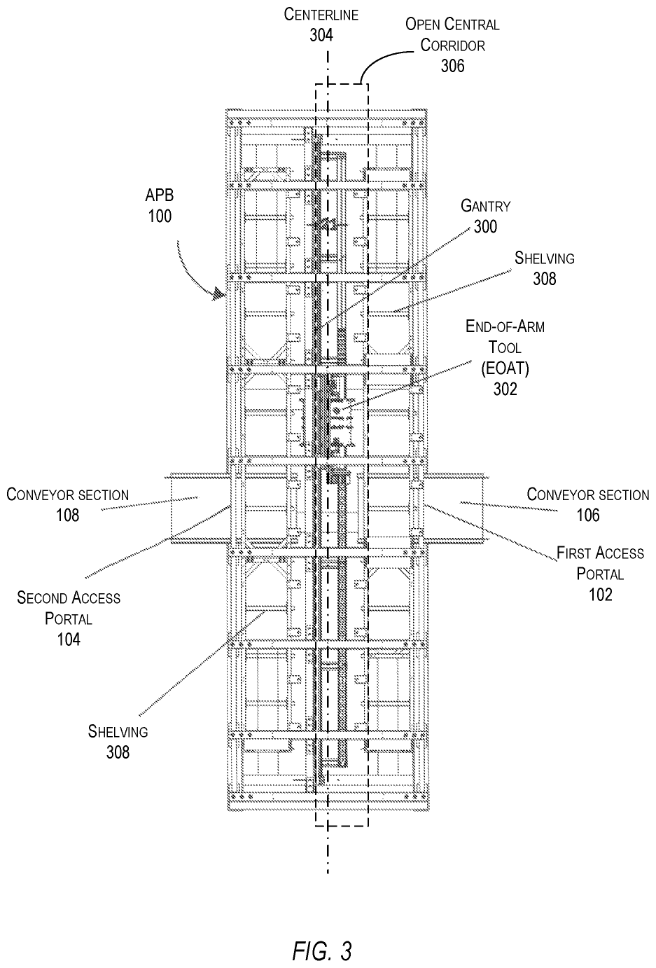

Turning to FIG. 3, a top plan view of the APB 100 is shown. In these examples, the APB 100 design is generally symmetric with structures arranged along either side of a centerline 304, promoting maximization of storage space and equipment reuse. In this example, a 2D gantry 300 includes an EOAT 302 and is installed parallel to and generally along the centerline 304 of the APB 100 within an open central corridor 306. The gantry 300 (carrying the EOAT 302) can thereby move in two dimensions though a center aisle of the open central corridor 306 of APB 100 to access shelving 308 installed along both sides of the APB 100, and access portals (102 and 104), which preferably may be installed on both sides of the APB 100. The EOAT 302 can preferably interface with all these different components as if it was interfacing with any standard shelf. The shelves 308 and portals 102 and 104 may be implemented in such a way as to be functionally identical in the way that they interface with the 2D gantry 300 and EOAT 302.

In order to optimize package handling, parcels may be effectively containerized on standardized carrying trays. Such an approach may increase the reliability of package handling and reduce the complexity of equipment required within the APB 100 for package handling, as EOAT 302 need only interface with a single uniform package tray structure, rather than attempting to handle packages directly having a variety of shapes, weights and sizes.

The 2D gantry 300 and EOAT 302 may use symmetric motions to move a tray with a package on top of it from an access portal (such as, for example, first access portal 102) to any number of storage shelves 308, or vice versa. These symmetric motions can move trays between three positions extended towards one side of the shelving, extended towards the other side of the shelving, or centered for transport within the open central corridor 306. In connection with movement between these positions, EOAT 302 may also selectively engage and disengage from a tray, as described in further detail below.

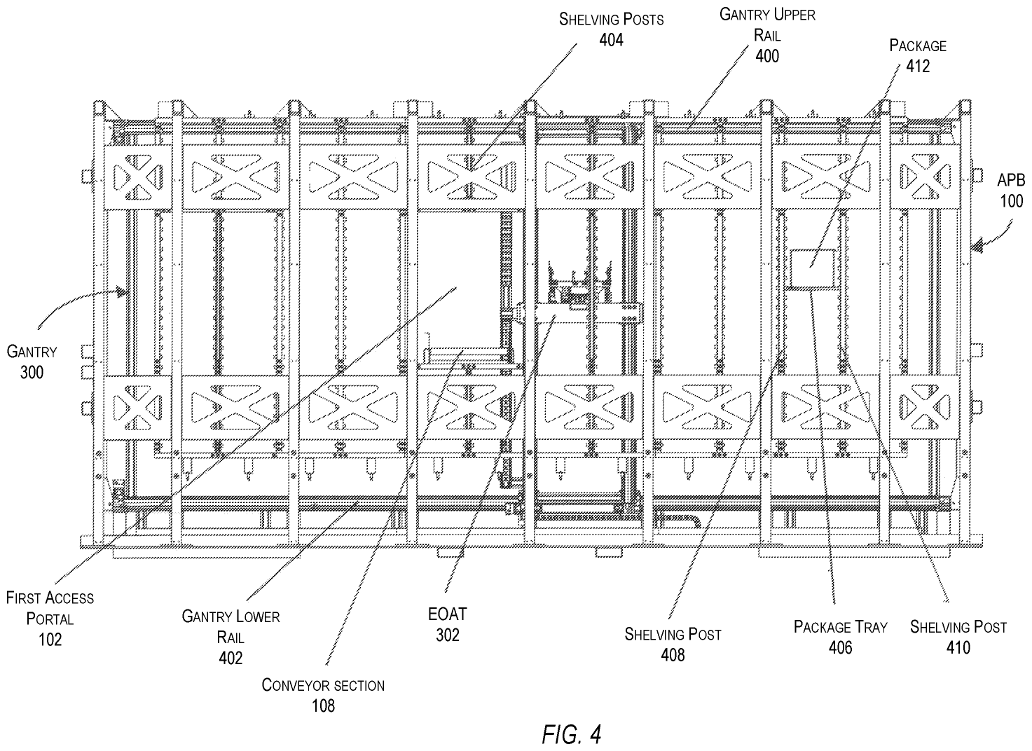

FIG. 4 is a right-side elevation view of the APB 100 shown in FIG. 3. The 2D gantry 300 includes upper rail 400 near the top of APB 100, and lower rail 402 near the bottom of the APB 100. In this example, the rails 400 and 402 extend horizontally for substantially the length of the APB 100. The rails 400 and 402 are thereby positioned to allow a maximum range of travel of the EOAT 302 throughout the APB 100. Maximizing the range of travel of the EOAT 302 may be important to the extent that a costly component of the APB 100 may be the linear actuators and motors which make up the 2D gantry 300 and the EOAT 302. In this circumstance, it may be important that the utilization of the linear actuators is maximized by enabling as much of the APB 100 as possible to be serviced by a single 2D gantry 300. Maximizing the range of travel of the EOAT 302 also maximizes the area available for shelving 308 (and, therefore, the package storage capacity of the APB 100). As an example, shelving posts 404 may be provided above the height of the portal (such as, for example, first access portal 102), thereby allowing storage of packages above the portal within the APB 100.

To the extent that packages are moved within the APB 100 on standard package trays, shelving 308 may be formed from posts having a number of slots along their length for engagement of package trays at varying elevations. As an example, edges of a package tray 406 are engaged with slots on the storage shelving posts 408 and 410 to a store package 412. Subsequent trays may be placed in shelving slots above or below as allowed by the heights of the packages contained in the trays.

The APB 100 structure illustrated in FIGS. 3 and 4 may thus be utilized to implement a package storage and retrieval system and process. For example, the EOAT 302 may retrieve the package tray 406 from the shelving 308 and align it with a portal (for example, first access portal 102) and extend it towards the portal. After a package arrives and is containerized into the package tray 406, as described in detail below, the EOAT 302 may move the package tray 406 into the center position within central corridor 306, at which point the 2D gantry 300 moves the package tray 406 to a desired storage location within shelving 308, at which time the EOAT 302 may again extend, to insert edges of package tray 406 into the shelving slots at the desired storage location, thereby storing the package in the shelving system. Likewise, when it is desired to retrieve a package from the APB 100, the 2D gantry 300 may position the EOAT 302 at a location within the shelving 308 at which the package tray 406 resides holding the desired package 412, at which point the EOAT 302 may retrieve the package tray 406, with the 2D gantry 300 then moving the package tray 406 to the location, in this example, of the first access portal 102 and de-containerizing the package 412, as described in detail below.

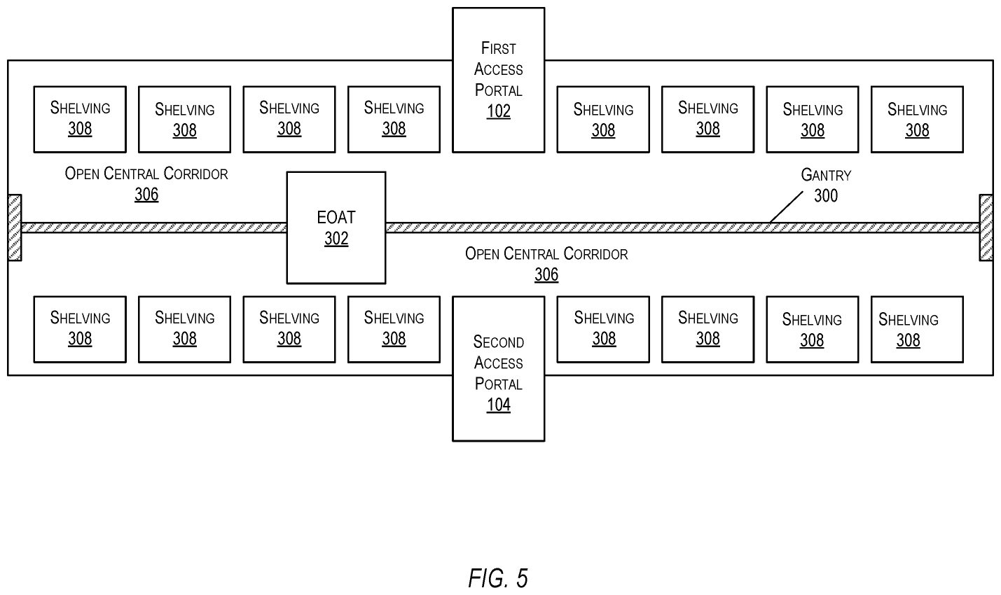

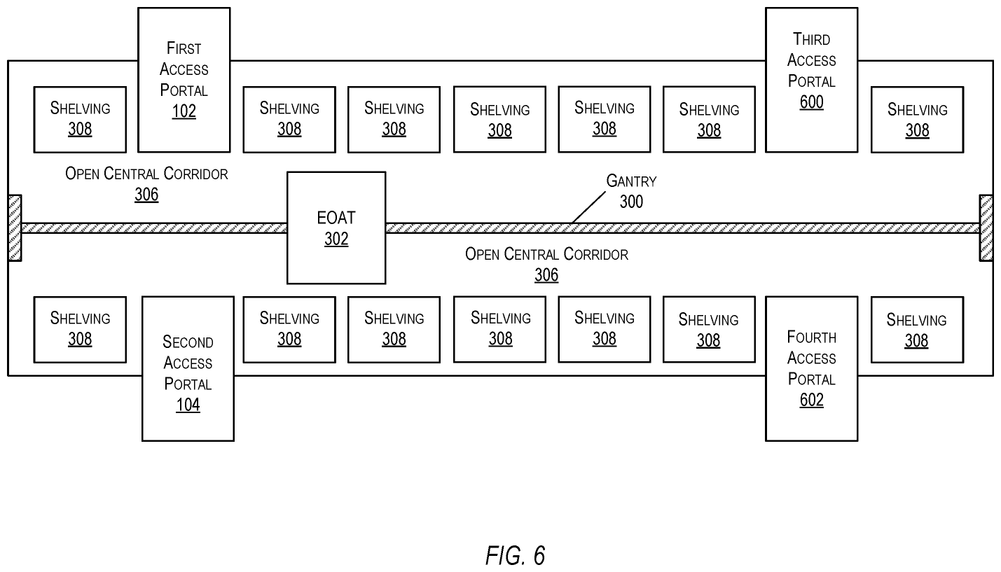

FIGS. 5 and 6 show alternative APB storage module configurations as simplified system block diagrams, with portals 102 and 104, shelves 308, center aisle (i.e., open central corridor 306), 2D gantry 300, and the EOAT 302. In FIG. 5, a system block diagram is shown of the configurations described in FIGS. 3 and 4, with the two portals 102 and 104 on opposite sides of open central corridor 306. For configurations with a single access portal on each side of the storage module, locating access portals 102 and 104 centrally along the length of an APB storage module may minimize average distance that must be traveled by an EOAT to store and retrieve parcels within the storage module. However, shelving sections 308 and portals 102 and 104 are in large part interchangeable within the APB 100 and can be configured to optimize the desired location of portals, and ratio of shelving to portals given particular operating conditions, e.g., as illustrated in an alternative configuration shown in FIG. 6. In this example, a third access portal 600 and fourth access portal 602 are shown. However, regardless of configuration, the portals (102 and 104 or 600 and 602, respectively) are preferably symmetric about open central corridor 306. Such symmetry may improve an operational rate by allowing reuse of a tray for containerization at one portal, e.g., portal 102, immediately following decontainerization at the portal opposite, e.g., portal 104, without necessitating repositioning of the 2D gantry 300.

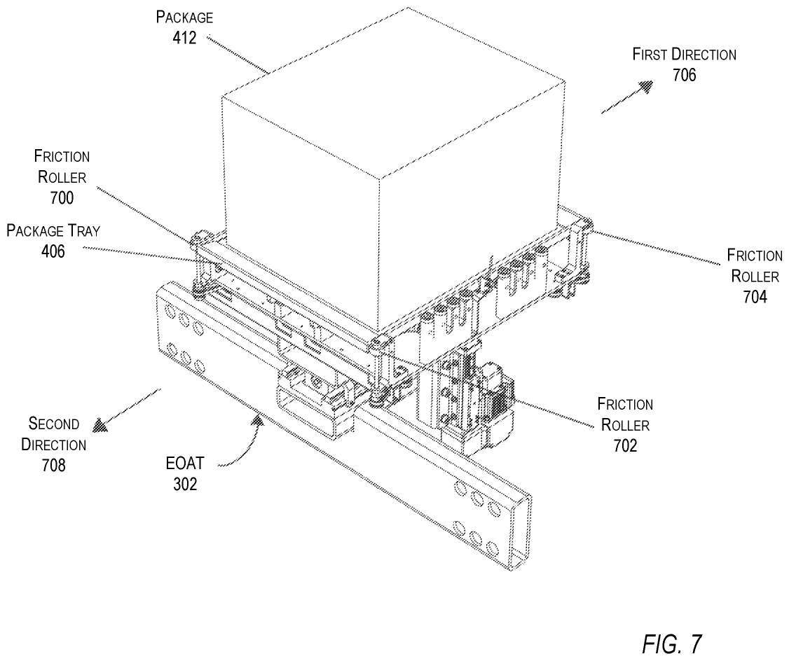

In FIG. 7, an upper perspective view of an example of an implementation of the EOAT 302, with a package tray 406, and package 412 loaded thereon is shown in accordance with the present disclosure. As described above, the EOAT 302 is used to pull out and push in package trays 406 in a motion perpendicular to the motion of the 2D gantry 300. The EOAT 302 is symmetric such that the package tray 406 can be pushed onto or pulled off a shelf (of shelves 308) on either side of the 2D gantry 300. The packages 412 of various sizes are placed on a standardized package tray 406. In some embodiments, the EOAT 302 may include friction rollers that grip the sides of the package tray 406 with friction to move the package tray 406 back and forth perpendicular to the motion of the 2D gantry 300. The rollers may be positioned at each corner of EOAT 302, such that rollers 700, 702, and 704 may operate to pull or push the package tray 406 in a first direction 706 or second direction 708. The EOAT 302 may also have unpowered support and side rollers (described further below) which allow the tray to slide smoothly along the EOAT 302 perpendicular to the motion of the 2D gantry 300.

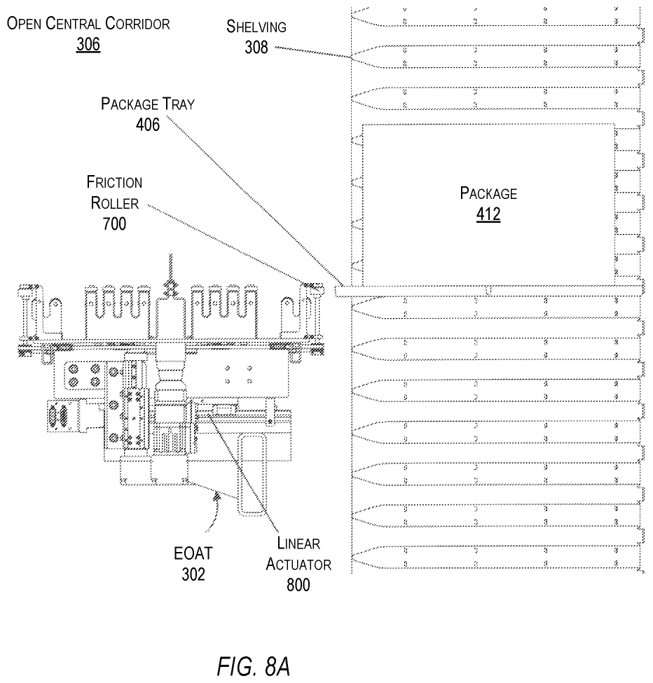

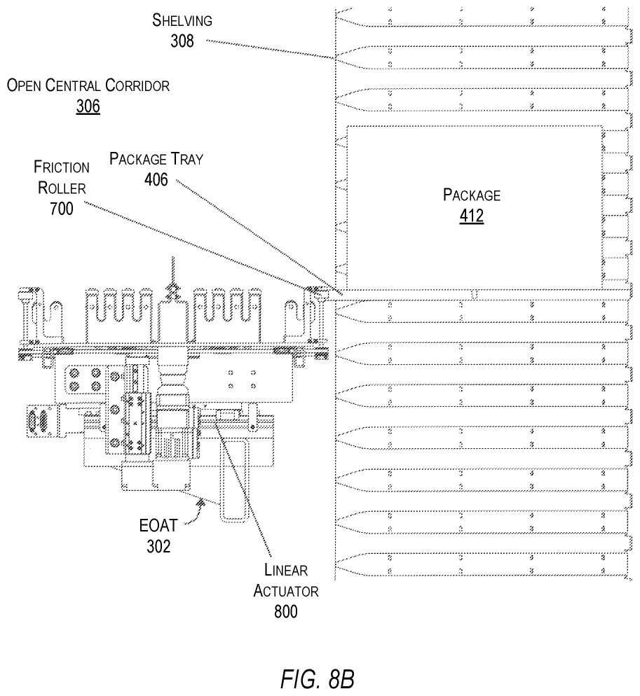

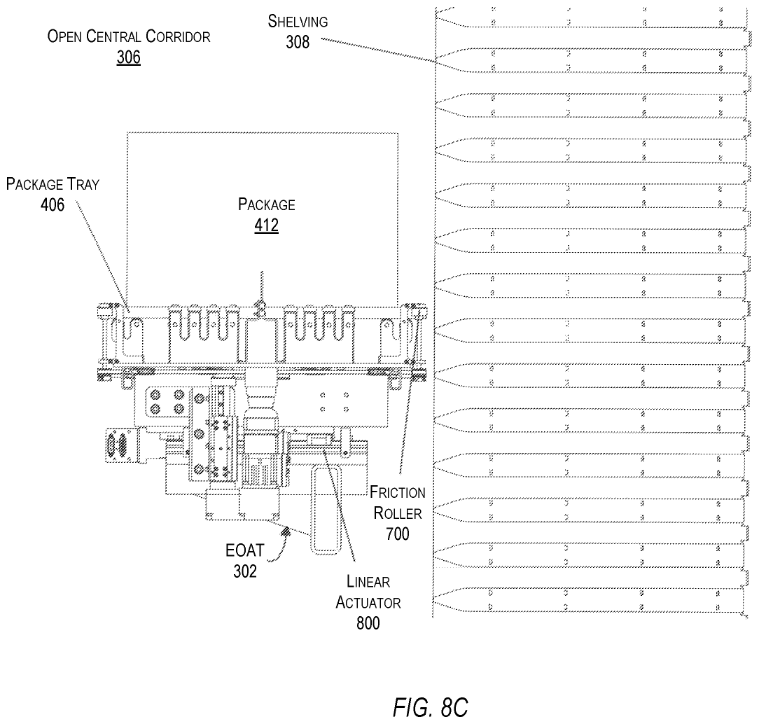

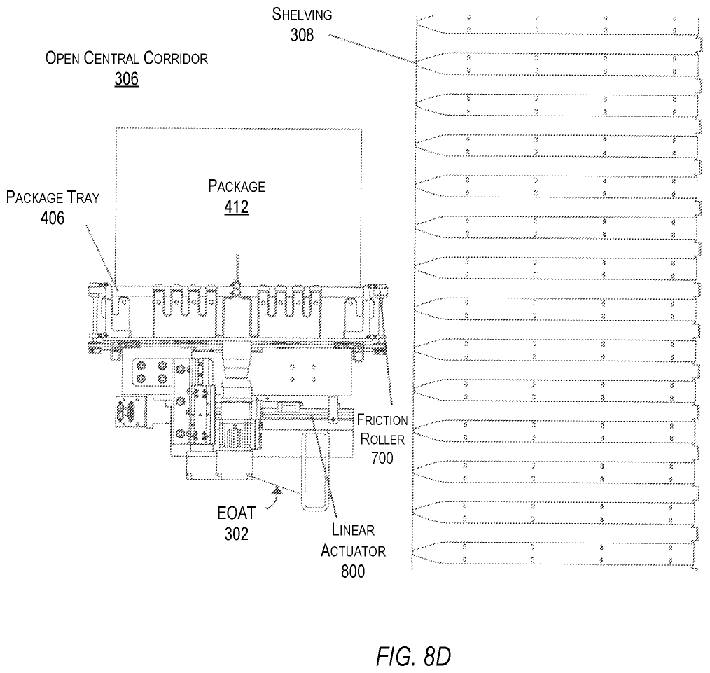

FIGS. 8A-8D illustrate the motion that allows the EOAT 302 to engage with the packaging tray 406 (e.g., using friction rollers 700), while the tray 406 is supporting package 412, thereby moving package 412 on to gantry 32 for transport. In FIG. 8A, the EOAT 302 starts in a position such that the 2D gantry 300 (not shown in FIGS. 8A-8D) is free to translate up/down and left/right along a central corridor 306 within APB 100, clearing the front of shelving 308. Once the 2D gantry 300 has moved the EOAT 302 into a position in front of a tray to be retrieved, then a linear actuator 800 can move the EOAT 302 forward or backward such that friction rollers 700 can engage with tray 406 (FIG. 8B). When the friction rollers 700 and package tray 406 are engaged, the EOAT 302 can pull the package tray 406 onto the EOAT 302 by using drive belts to rotate the friction rollers 700, as illustrated in FIG. 8C. Finally, the linear actuator 800 can pull the EOAT 302 back into the position seen in FIG. 8D such that EOAT 302 is clear of shelf 308 and 2D gantry 300 is free to translate within central corridor 306. This same sequence occurs in the reverse order to allow the EOAT 302 to push the tray 406 onto a shelf 308. These sequences also allow the EOAT 302 to push or pull the package tray 406 into or out of the portal (i.e., either first access portal 102 or second access portal 104). In the case of interacting with a portal, the conveyor (i.e., either conveyor section 106 or conveyor section 108) may additionally be driven to the extent that it assists with the push or pull process. In any case, the package tray 406 may or may not be carrying a package.

Friction roller 700 mechanisms may be beneficially used at least in part because they can be used to make a symmetric EOAT 302 that can access both sides of the gantry, thereby maximizing utilization of the costly 2D gantry 300 and reducing the overall cost per package managed by the APB 100.

As apparent from these figures, sizing of the shelving 308 may be designed to allow a forward protrusion of the package tray 406 to be exposed so that it can be easily accessed by the EOAT 302. Alternatively, in some embodiments the forward end of the package tray 406 can be interior to the shelving 308 front, if so desired. As discussed previously, it is understood by those of ordinary skill in the art that the functional heights of the shelves 308 may be varied, that is, trays may be placed in shelving slots as allowed by the heights of the packages contained therein, meaning that shorter and taller packages may be stored in the same shelving system without wasting vertical space, thus maximizing loading density.

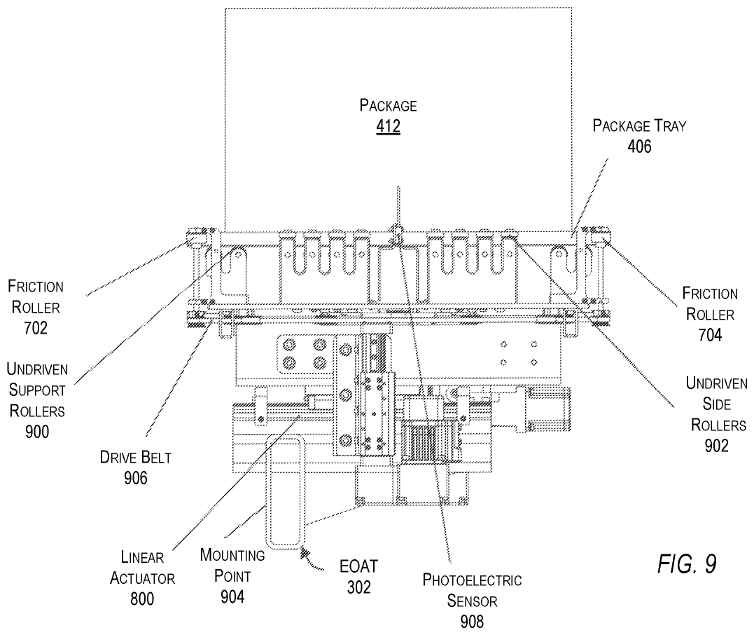

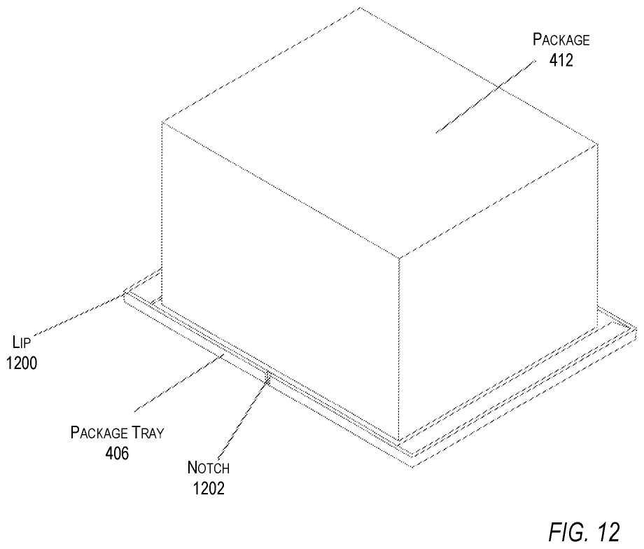

FIG. 9 is the side view of the EOAT 302. The bottom of the standard package tray 406 is supported by undriven support rollers 900 and is gripped on two sides by the friction rollers 702 and 704. In this example, the package tray 406 is also guided laterally by undriven side rollers 902. The EOAT 302 is mounted onto the 2D gantry 300 (not shown) using a mounting point 904. The linear actuator 800 enables portions of the EOAT 302 (including the friction rollers 702 and 704) to move back and forth to grip the package tray 406 and pull it onto EOAT 302, or to release the package tray 406 and push it out towards a shelf 308 or towards a portal (i.e., either first access portal 102 or second access portal 104). The drive belt 906 powers rotation of the friction rollers 702 and 704. In this example, a photoelectric sensor 908 is used to detect a notch 1202 (See FIG. 12), which is a feature present on both sides of the package tray 406, and provides control feedback for the drive belt system of the friction rollers 702 and 704, which enables accurate positioning of the package tray 406 with respect to EOAT 302. As discussed earlier, it is appreciated that even though only two sets of friction rollers (i.e., 702 and 704) are shown in the view, there are a set of friction rollers at each corner of the EOAT 302.

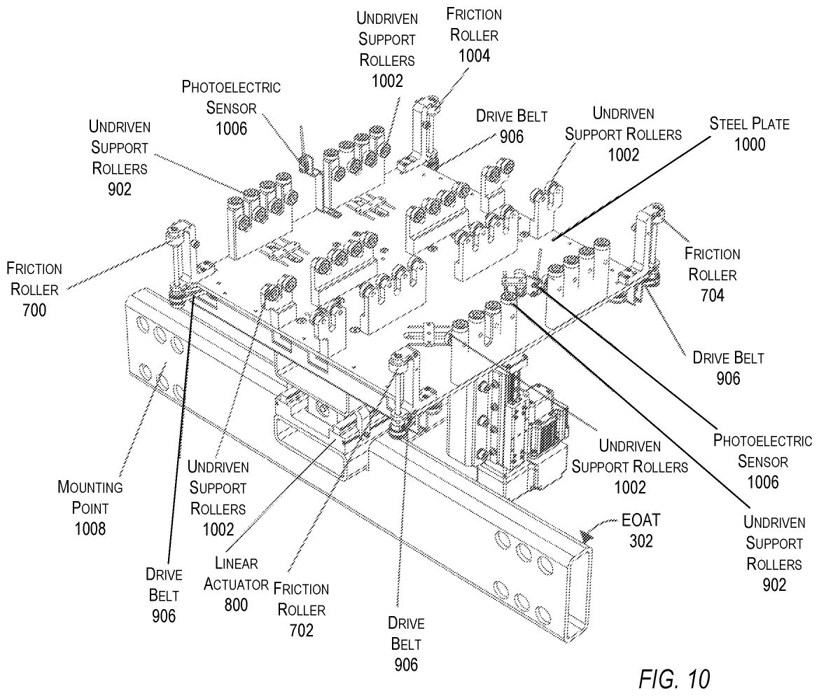

FIG. 10 is an upper perspective view of the EOAT 302, with no package tray 406 engaged. In this example, a single steel plate 1000 is utilized to locate various components relative to one another, including tray support rollers 1002, side rollers 902, friction rollers 700, 702, 704, and 1004, photoelectric sensors 1006, and a mounting point 1008.

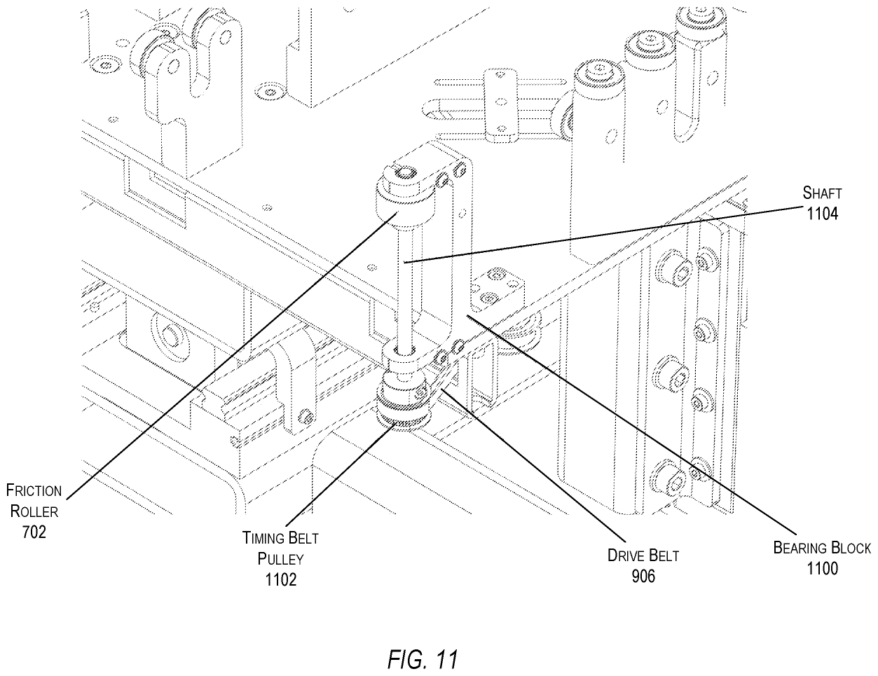

FIG. 11 is a close-up perspective view of a mechanism for EOAT 302 to engage with the package tray 406, utilizing a friction roller (i.e., friction roller 702), a bearing block assembly 1100, and a drive pulley 1102 (also referred to as a timing belt pulley). The friction roller 702 engages with the side of the package tray 406 (not shown) and the friction roller 702 rotates on shaft 1104 retained in the bearing block 1100, where the shaft 1104 and friction roller 702 are driven by the timing belt pulley 1102.

In FIG. 12, an upper perspective view is shown of the package tray 406 supporting a typical package 412. In this example, each package tray 406 can hold packages up to a maximum base dimension equivalent to the length and width of the interior of the tray and a maximum height dimension limited only by the stability of the package against tipping under expected acceleration profiles. In this example, the package tray 406 has a lip 1200, which prevents the packages 412 from sliding off the package tray 406 when moving between the portals (i.e., either first access portal 102 or second access portal 104) and the tray shelves 308. In this example, the package tray 406 also includes a notch 1202.

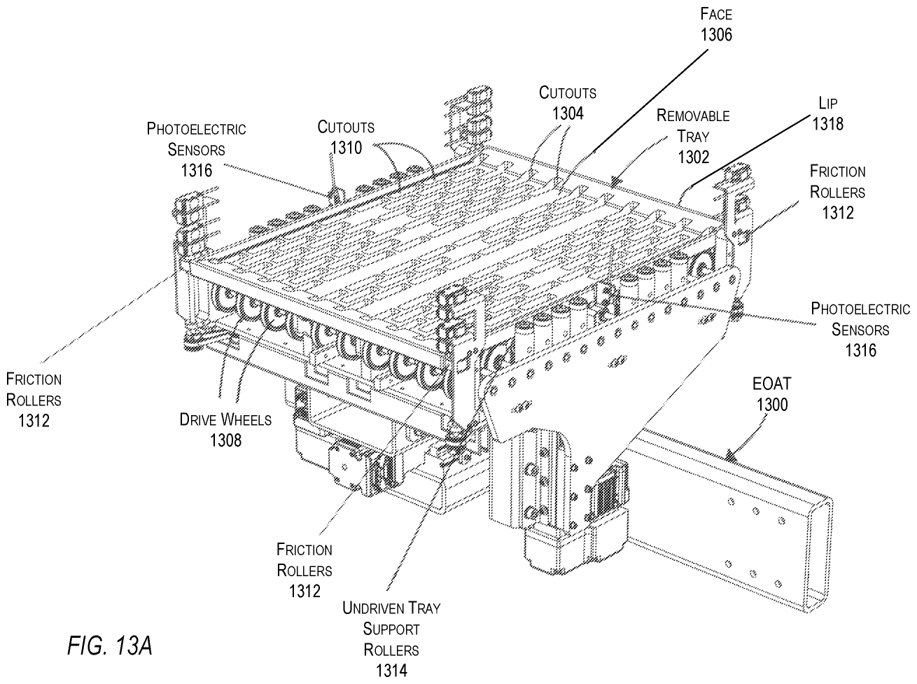

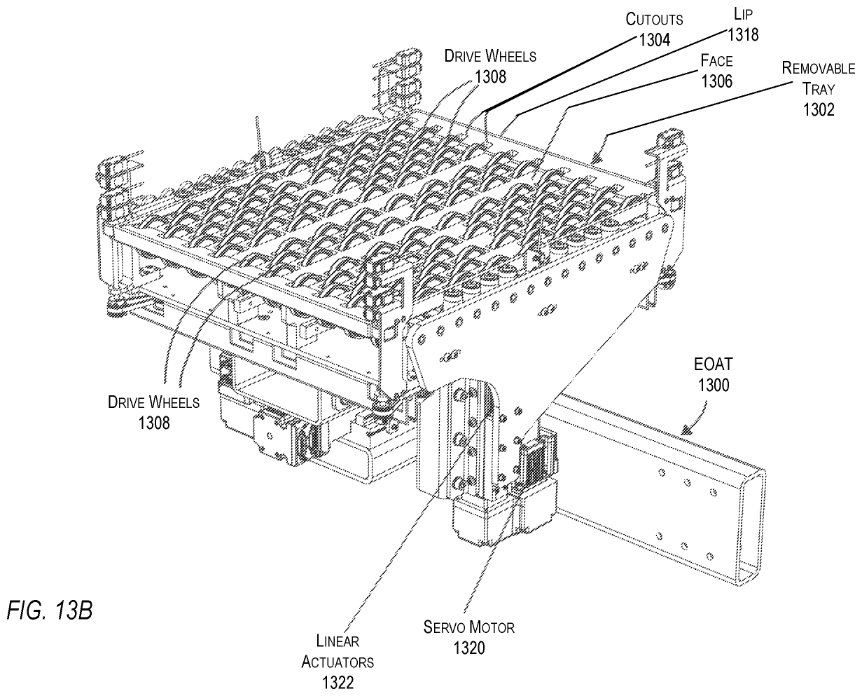

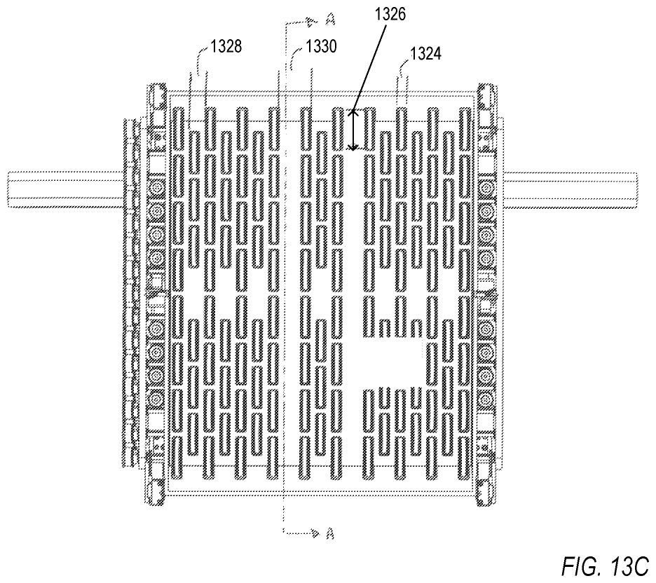

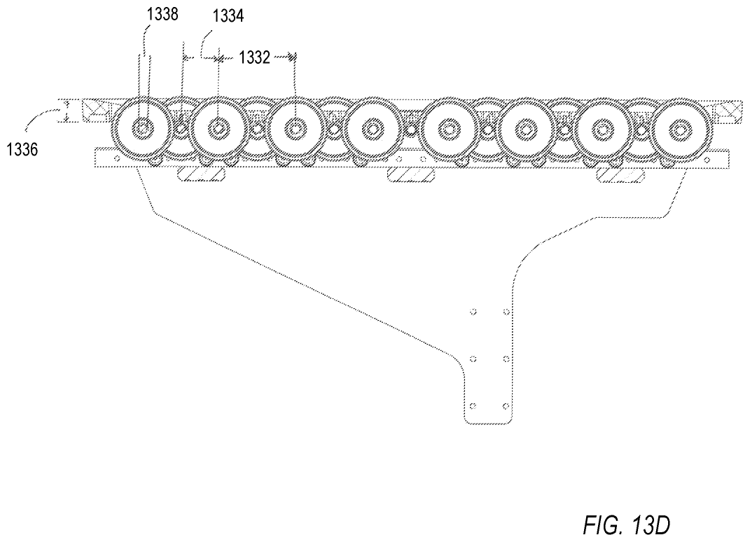

FIGS. 13A and 13B are perspective front views of an alternative exemplary EOAT 1300 loaded with an example empty removable tray 1302 having cutouts 1304 in its face 1306. This example utilizes drive wheels 1308 that are elevated and lowered through the cutouts 1310 to “drive” a package (not shown) onto and off the removable tray 1302. In a pre-loading scenario (e.g., placing an empty removable tray 1302 onto the EOAT 1300), reference can be made to the descriptions in FIGS. 7-11, wherein friction rollers found in those embodiments can be similarly found 1312 on the EOAT 1300 to bring an empty tray 1302 onto undriven tray support rollers 1314. Positioning of the tray 1302 with respect to the EOAT 1300 can be achieved using feedback from photoelectric sensors 1316 that detect position features on tray 1302.

FIG. 13A shows an operational mode where a top of the drive wheels 1308 are below cutouts 1304 of the tray 1302 centered within the EOAT 1300. FIG. 13B shows another operational mode where the drive wheels 1308 are raised into the tray's 1302 cutouts 1304, where the top of drive wheels 1308 are above the face 1306 of the tray 1302. The number of, and positioning of, the cutouts 1304 within the face 1306 are such that they match the number of, and positioning of, the drive wheels 1308. In some alternative embodiments, the number of cutouts 1304 may exceed the number of drive wheels 1308. The cutouts 1304 may be in the form of slots, as shown, to accommodate the package drive wheels 1308 or of another shape, according to design preference. The tray 1302 may also have a raised lip 1318 around one or more sides of the tray 1302 with features such as ramps or fillets which may be used to keep the package contained within the tray 1302 but also facilitate ease of containerization and de-containerization as compared to a plain right-angled edge.

The package drive wheels 1308 on the EOAT 1300 are raised and lowered using any one or more of a servo motor 1320, pulley (not shown) and/or linear actuators 1322. In some embodiments, the weight of the package drive wheels 1308 may assist in their lowering movement. As the package drive wheels 1308 are raised, they protrude through the cutouts 1304 on the face 1306 of the tray 1302 (and above lip 1318, if present). The package drive wheels 1308 are raised until they are higher than a top edge of the tray 1302, effectively creating a conveyance plane formed by the tops of the package drive wheels 1308.

FIG. 13C is a top plan view of the example tray 1302 showing one possible arrangement of the cutouts 1304. As an example, the cutouts 1304 in the tray 1302 may be slightly larger than the drive wheels 1308. In this example, the drive wheels 1308 are sized to be approximately 10 mm in width (dimension 1324) and approximately 54 mm in length (diameter) (dimension 1326). Non-aligned cutouts were separated approximately 22 mm (dimension 1328) from each other. Aligned cutouts were separated approximately 44 mm (dimension 1330) from each other. The cutout pattern can be uniform across the tray 1302 or have some instances removed, as evident in the larger separations in the midline of the tray 1302 and between certain adjacent rows. In this example, the tray 1302 can be several millimeters thick or several centimeters or more, depending on design preference.

FIG. 13D is a sectional cut view A-A (of FIG. 13C), with some components hidden for clarity, showing a staggering of the package drive wheels 1308. As an example, the radial spacing between axes of aligned drive wheels having approximately 65 mm (dimension 1332) and between staggered drive wheels of approximately 32.5 mm (dimension 1334). As a further example, the total height of the tray may be approximately 19 mm (dimension 1336) such that drive wheels 1308 having diameter (dimension 1326) and axle diameter 8 mm (dimension 1338) may protrude above top edge of tray 1302 when raised as in FIGS. 13B-13D.

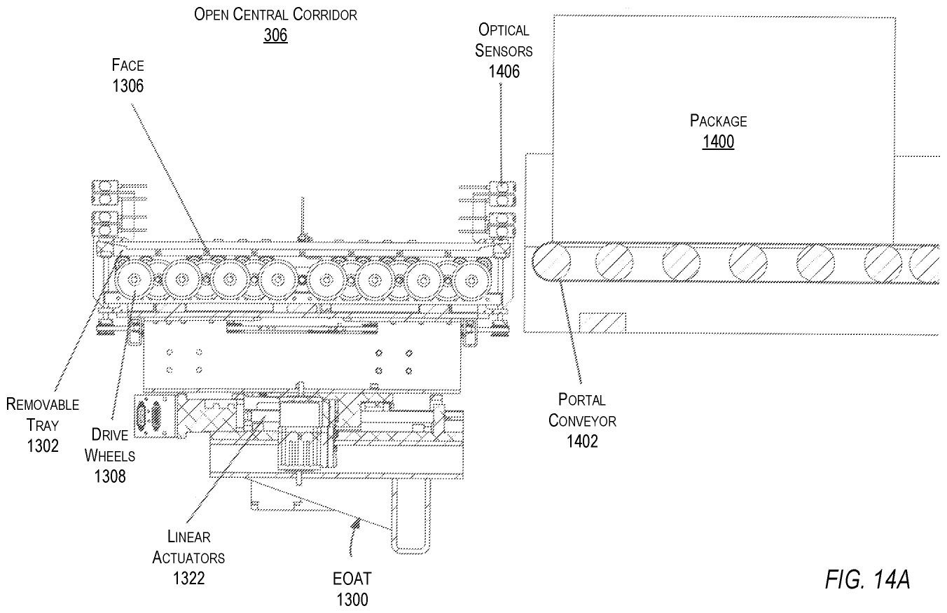

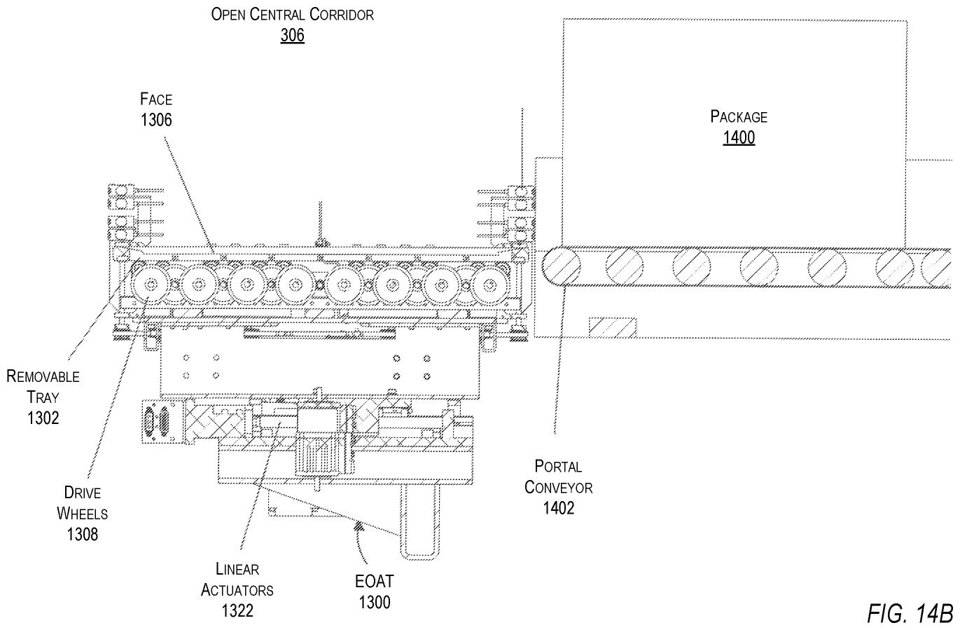

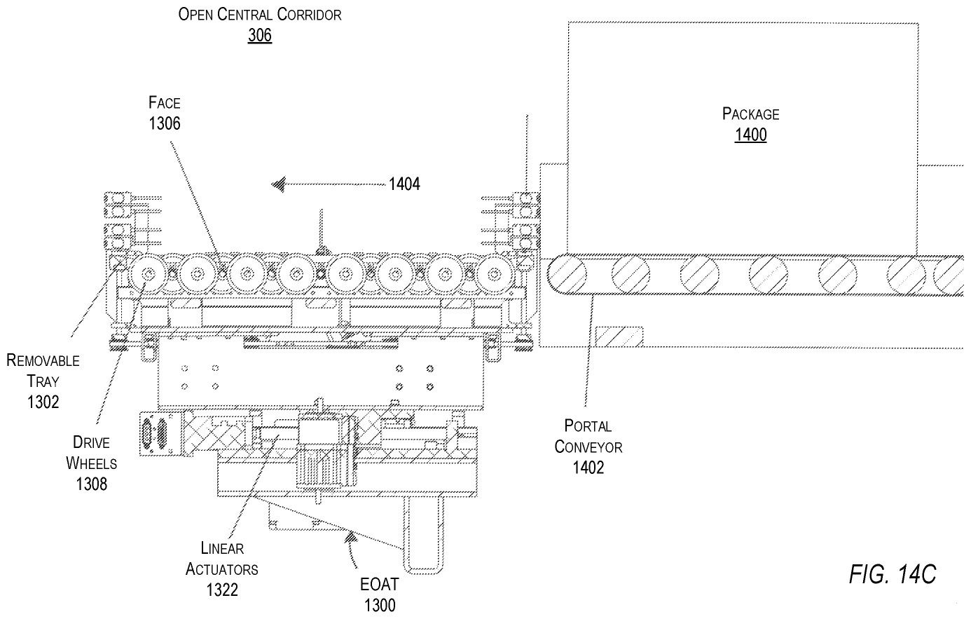

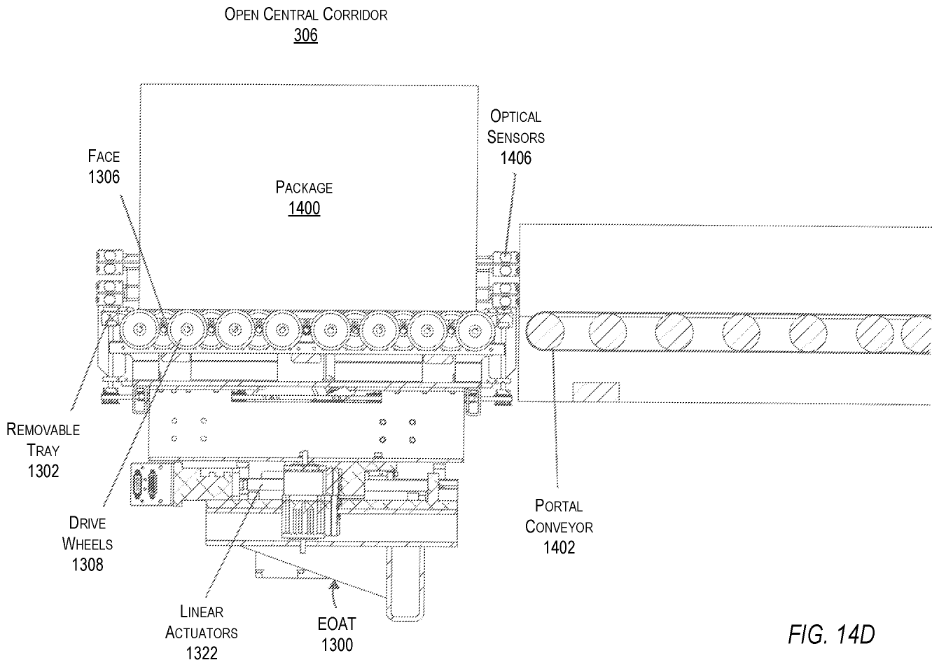

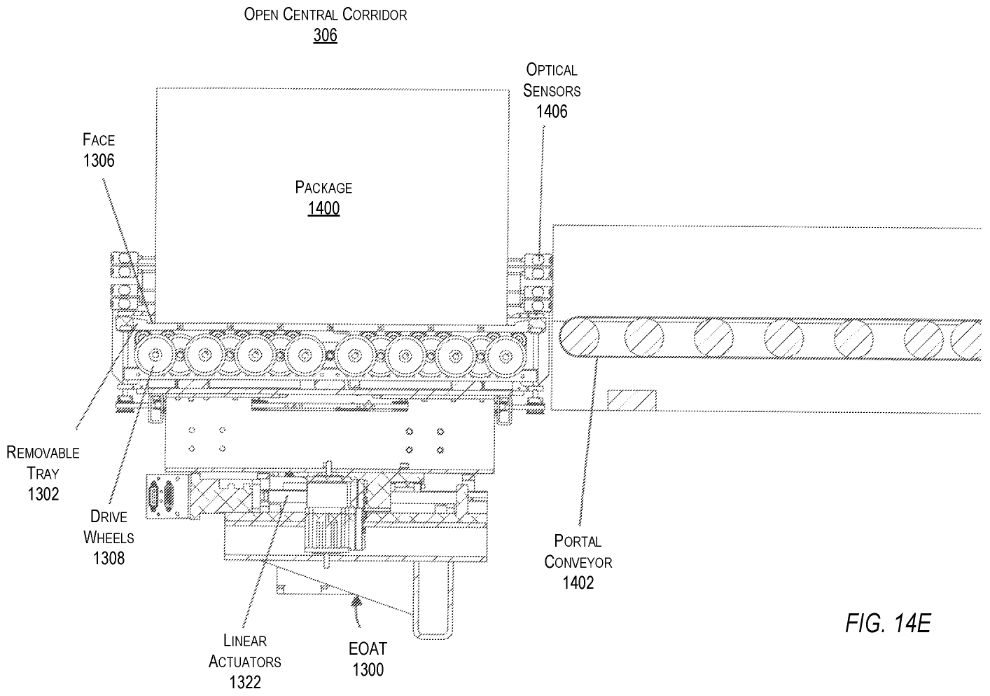

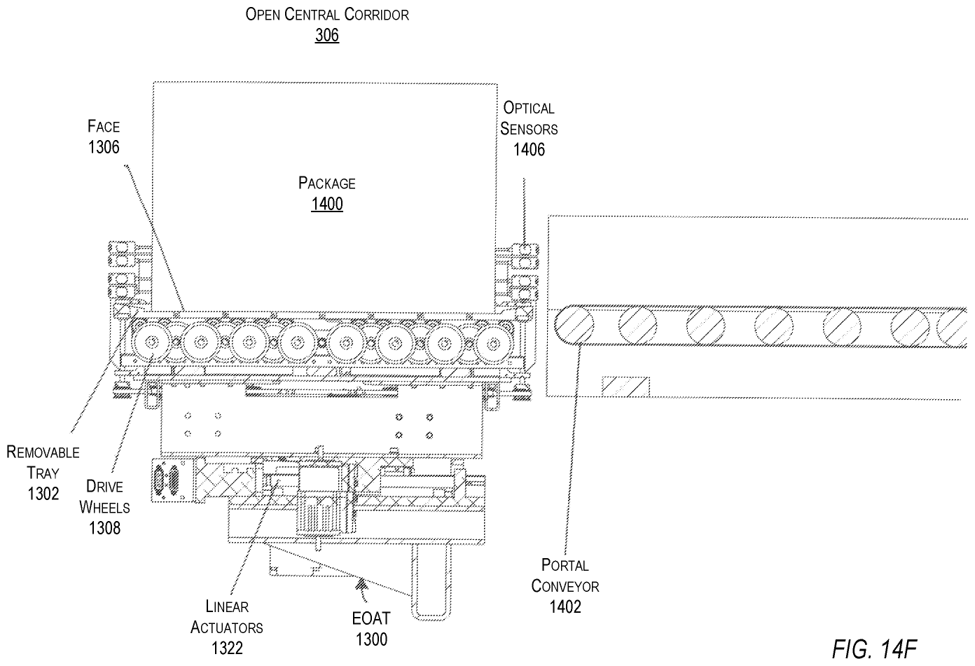

FIGS. 14A-14F illustrate the motion that allows EOAT 1300 to a containerize package 1400, thereby moving package 1400 on to a 2D gantry 300 (not shown) for transport. In FIG. 14A, the EOAT 1300 starts holding tray 1302 in a position such that the 2D gantry 300 is free to translate up/down and left/right along a central corridor 306 within APB 100, clearing the front of shelving 308 (not shown) and portal conveyor 1402. Once the 2D gantry 300 has moved the EOAT 1300 carrying tray 1302 into position in front of portal conveyor 1402, then the linear actuator 1322 can move the EOAT 1300 forward (FIG. 14B) such that tray 1302 is as close as possible to portal conveyor 1402 without any physical interference. As, or when, package drive wheels 1308 are moved into a raised position (FIG. 14C), the package drive wheels 1308 are driven (e.g., spun) in a designated direction. As an example, for loading a package onto the tray 1302 on EOAT 1300, the package drive wheels 1308 are spun in a “containerize” direction 1404 (e.g., into the tray 1302) and portal conveyor 1402 is started having the same drive direction 1404, with packages thereupon. The conveyance plane formed by the elevated package drive wheels 1308 is set at a same or lower level than conveyor 1402, thus enabling the transference of package 1400 onto the conveyance plane. With the conveyor 1402 operating, the package 1400 will be “rolled” off conveyor 1402 and some portion of the package 1400 will contact and ride onto the elevated package drive wheels 1308. With the package drive wheels 1308 being driven, the driven direction 1404 carries the package 1400 further “into” the tray 1302 (FIG. 14D). One or more optical sensors 1406 provide feedback to the package drive wheels 1308 so that the package 1400 can be centered on the tray 1302, if so desired. When the package 1400 is detected and moved to its desired position in the tray 1302, the package drive wheels 1308 can stop driving. Thereafter, the package drive wheels 1308 can recede back through the cutouts 1304, letting the package 1400 ultimately rest and be supported by the face 1306 of the tray 1302 (FIG. 14E). Finally, the linear actuator 1322 can pull the EOAT 1300 back into the position seen in FIG. 14F such that EOAT 1300 is clear of the conveyor 1402 and the 2D gantry 300 is free to translate within central corridor 306. The order of the steps in the sequence may also be altered such that the extension or retraction of linear actuator 1322 may occur before or after the package drive wheels 1308 are raised or lowered, as this achieves the same overall result.

When it is time to shelve a package 1400 loaded onto a tray 1302, the 2D gantry 300 (see FIGS. 3-4) moves the EOAT 1300 to a shelf storage location and the tray 1302 (containing a package) is discharged from the EOAT 1300 into the shelf storage location, using friction rollers 1312 as similarly described in FIGS. 8A-8D.

Conversely, when it is time to transfer a package out of a tray 1302 to the portal conveyor 1402, the tray 1302 containing a package 1400 retrieved from a shelf storage location, is loaded onto the EOAT 1300. As, or when, the package 1400 is suspended above the tray's 1302 face 1306 by the package drive wheels 1308, the package drive wheels 1308 can be driven in a direction towards the portal conveyor 1402 that itself can be similarly driven, thus “pushing” the package 1400 onto conveyor 1402 and off the EOAT 1300, while the tray 1302 is retained therein. The one or more optical sensors 1406 provide feedback to allow the package 1400 to fully clear the EOAT 1300. When the package 1400 is fully off the tray 1302, the package drive wheels 1308 can stop driving and can be lowered.

It is expressly understood that the drive wheels (and accommodating cutouts) described above may be differently sized, shaped, or arranged than shown, according to design preference and implementation. Further, the driving speed of the drive wheels may be uniform across all the drive wheels or at different speeds and/or directions for different sets of drive wheels (e.g., for spinning a package around in the tray). Thus, independent manipulation of one or more sets of drive wheels may be contemplated as another possible feature.

While FIGS. 13A-D and 14A-F illustrate an embodiment that has upward and downward moving package drive wheels 1308 so as to provide a mechanism to move a package 1400 “into/out of” a stationary tray, it is understood that other modifications, changes to the drive wheels, tray, and arrangement may be made without departing from the spirit and scope of this disclosure. As one non-limiting example, the tray may be raised and lowered versus the drive wheels, whereas the drive wheels are fixed in position and the tray is vertically moved, etc. Further, while the term “wheels” is used in these examples, it is understood that other rotating, turning or otherwise moving mechanisms may be utilized according to design preference. As a non-limiting example, a series of rotating spheres may be devised instead of the “wheels”, or mini-conveyors, etc.

Embodiments of the EOAT described herein may be beneficially utilized in a variety of parcel storage applications, including both standalone PRS applications as well as applications involving multiple interconnected storage modules operating in concert. In some such applications, alternative storage module configurations may be beneficially utilized.

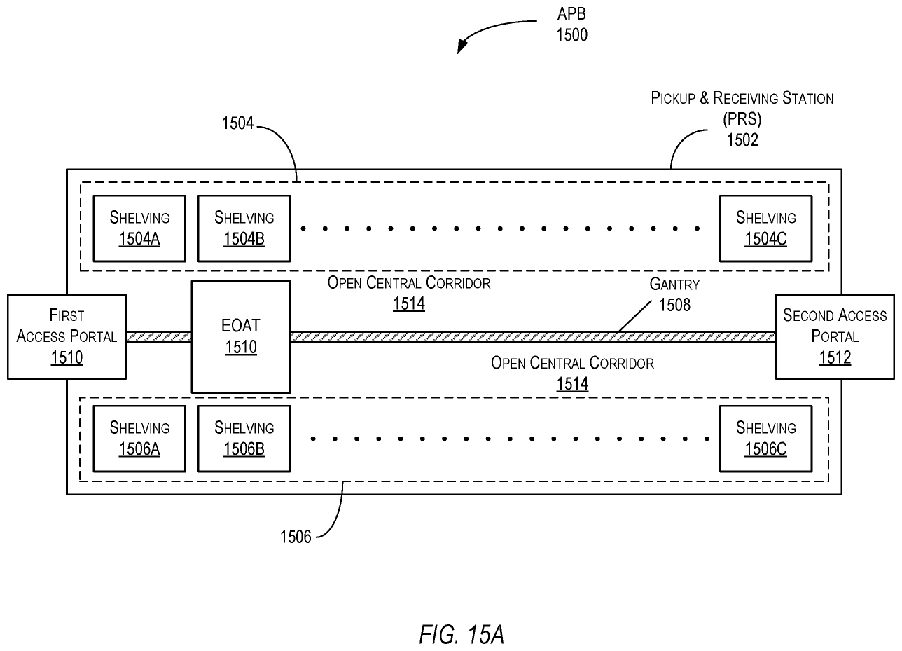

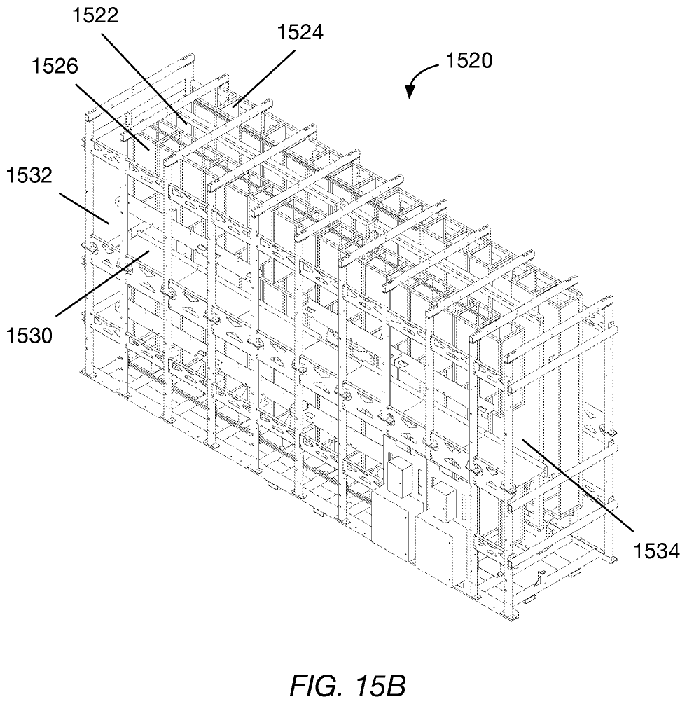

Turning to FIG. 15A, a system block diagram of another example of an implementation of an APB 1500 is shown in accordance with the present disclosure. In the embodiment of FIG. 15A, the APB 1500 includes a pickup and receiving station (PRS) 1502 having access portals at each end of its central corridor, permitting loading and unloading of PRS 1502 from its ends. As described further below, end loading of a PRS 1502 can facilitate high density APB systems in which multiple PRS are arranged closely side-by-side, with interconnecting material handling systems enabling multiple PRS to work together in storing, retrieving and organizing sets of packages.

In particular, PRS 1502 may include a first plurality of shelves 1504, a second plurality of shelves 1506, a 2D gantry 1508, an EOAT 1510, and a first access portal 1510, and a second access portal 1512. In this example, the second plurality of shelves 1506 is located opposite the first plurality of shelves 1504 along a central corridor 1514. In this example, the first plurality of shelves 1504 may include any number of shelves from 1504A, 1504B, to 1504C. Similarly, the second plurality of shelves 1506 may include any number of shelves from 1506A, 1506B, to 1506C. Unlike the previous discussed examples, in this example, the first access portal 1510 and second access portal 1512 are located along a centerline along the central corridor 1514 between the first plurality of shelves 1504 and the second plurality of shelves 1506 that is parallel to the 2D gantry 1508. As before, the first access portal 1510 and second access portal 1512 are configured to receive one or more packages from outside the PRS 1502 and the first access portal 1510 and second access portal 1512 are positioned proximate the 2D gantry 1508 such that the EOAT 1510 may extend one of the trays towards the portal (either the first access portal 1510 or the second access portal 1512) for placement of a package thereon. As discussed earlier, the EOAT is configured to selectively engage and disengage from one or more package support trays, and move the one or more package support trays between a central position, a position extended in a first direction perpendicularly to the 2D gantry 1508 (e.g., in the direction of the first plurality of shelves 1504), and a position extended in a second, opposite direction perpendicularly to the 2D gantry 1508 (e.g., in the direction of the second plurality of shelves 1506). In this example, the PRS 1502 may include internal shelving rails (not shown) within the PRS 1502 and on the one or more sides of the central corridor 1514, adapted for engagement and support of the one or more package support trays for storing supported thereon.

Alternatively, in other embodiments, the PRS 1502 may only include a single plurality of shelves (such as, for, example plurality of shelves 1504) on one side of central corridor 1514. However, such embodiments may provide less parcel storage for a given amount of ground area dedicated to the PRS or a given gantry and EOAT assembly.

In some embodiments, particularly for an APB comprised of multiple PRS storage modules interconnected by conveyors or material handling systems as described further below, it may be desirable to incorporate an internal conveyor extending along the length of a PRS. Such an internal conveyor may be utilized to, e.g., minimize the distance over which a gantry and EOAT must transport packages within the PRS. The gantry and EOAT may be needed only to transport parcels between a shelving area and a closest portion of the internal conveyor, rather than transporting parcels the entire length of the PRS to an input or output portal. The conveyor may then be utilized to transport parcels the remaining distance into or out of the PRS. Such an internal conveyor arrange may therefore be utilized to maximize parcel processing rate, as well as the proportion of time during which the gantry and EOAT are utilized for highest-value tasks.

Because an open central corridor may still be required within a PRS to permit travel of the gantry and EOAT, in some embodiments, an internal conveyor may be routed through a parcel storage area on one side of the PRS. In such an arrangement, the internal conveyor may consume space that could otherwise be used for shelving, thus sacrificing some amount of storage area. However, in some applications, particularly high density matrices of multiple PRS (as described below), the corresponding increase in parcel rate provided by the internal conveyor may be a desirable tradeoff for a small reduction in per-PRS storage area.

FIG. 15B is a perspective view of a PRS storage module configured with end portals and internal conveyor, as described above. PRS storage module 1520 includes shelving area 1524 on one side of an open central corridor 1522, and shelving area 1526 on an opposite side of central corridor 1522. A 2D gantry and EOAT (not shown) extend through central corridor 1522, as described hereinabove in connection with other embodiments. Internal conveyor 1530 extends the length of module 1520. In order to keep central corridor 1522 open, internal conveyor 1530 is positioned next to central corridor 1522, extending through a portion of shelving area 1526. An EOAT traveling within central corridor 1522 may therefore pick up and deposit parcels onto internal conveyor 1530 at any point along its length. Further, an EOAT may store parcels within shelving area 1526 at locations above and below internal conveyor 1530. A first access portal 1532 may be provided at one end of storage module 1520 and internal conveyor 1530, and a second access portal 1534 may be provided at an opposite end of storage module 1520 and internal conveyor 1530, such that parcels may be introduced into and removed from PRS storage module 1520 via access portals 1532 and 1534 during use.

As mentioned, while various PRS embodiments as described hereinabove may be utilized in a standalone manner, in some applications, it may be desirable to interconnect multiple PRS storage module “trees” into a matrix or “forest” of storage modules to form a high-density, high capacity APB. Such embodiments may provide a modular, scalable, high density and highly-automated parcel buffering system beneficial for a variety of applications. In some such embodiments, PRS with end-configured access portals may be particularly beneficial, enabling various combinations of parallel-arranged PRS that are physically positioned side-by-side adjacent to one another, and/or “series” arranged PRS placed end-to-end with an outlet portal of one PRS feeding an inlet portal of another. Such an arrangement may be utilized to address a wide range of parcel handling requirements. For example, adding additional PRS storage modules in parallel and in series provide various increases in both the typical rate at which an APB may intake or output parcels, and/or the total storage capacity of the APB. Different PRS may also implement differing tray sizes, optimizing each PRS for a particular range of parcel sizes and providing the APB as a whole with a greater range of parcel sizes that may be efficiently processed.

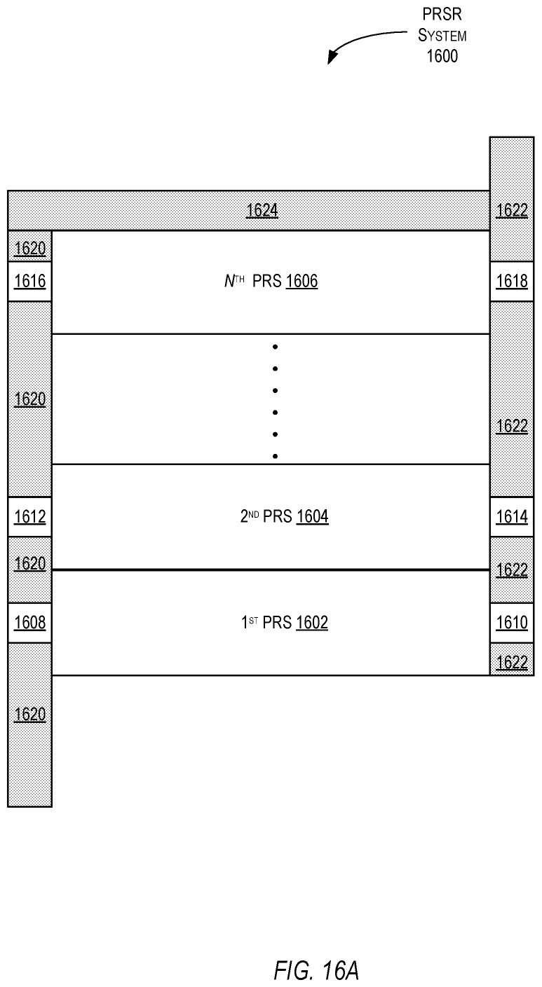

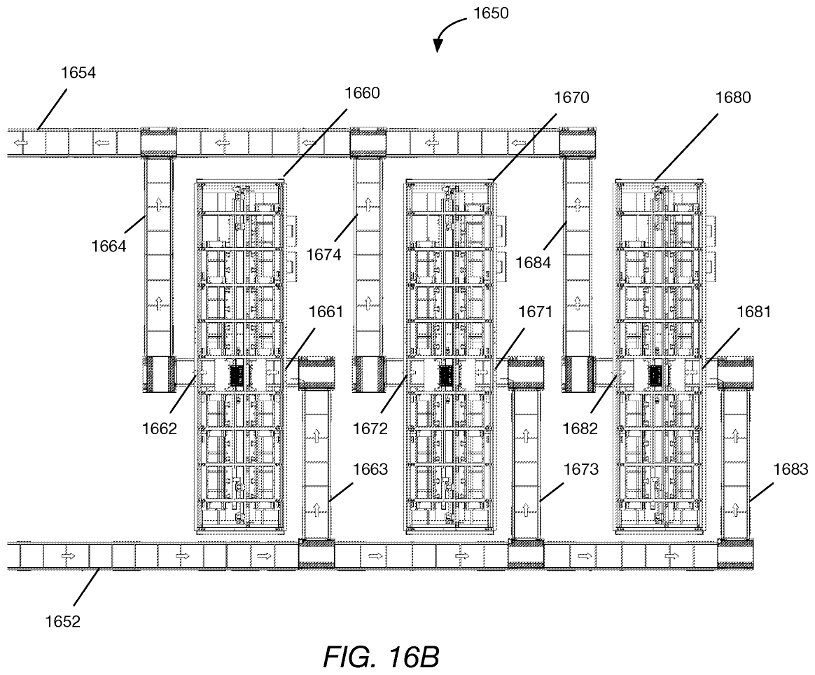

In FIG. 16A, a system block diagram is shown of an example of an implementation of an APB formed of package receiving, storing, and retrieving (PRSR) system 1600 in accordance with the present disclosure. In this example, the PRSR system 1600 includes N number of PRS storage modules (i.e., first PRS 1602, second PRS 1604, and Nth PRS 1606) placed in parallel to one another. Each PRS includes a first access portal and a second access portal where each PRS is configured like PRS 1502. As an example, the first PRS 1602 includes a first access portal 1608 and a second access portal 1610, the second PRS 1604 includes a first access portal 1612 and a second access portal 1614, and the Nth PRS 1606 includes a first access portal 1616 and a second access portal 1618, respectively. The PRSR system 1600 also includes an input conveyer system 1620 physically connected to the first access portal 1608, 1612, and 1616 of all the PRS 1602, 1604, and 1606, respectively. Further, the PRSR system 1600 includes an output conveyor system 1622 physically connected to the second access portal 1610, 1614, and 1618 of all the PRS 1602, 1604, and 1606, respectively.

In this example, the PRSR system 1600 allows for a high capacity of packages to be processed, where a large number of packages can be introduced to the PRSR system 1600 via the input conveyor 1620 and the respective first access portals 1608, 1612, and 1616. These packages can be individually processed by each of the PRS 1602, 1604, and 1606 in parallel. Such processing may include storing in the internal plurality of shelving in each of the PRS 1602, 1604, and 1606 or organizing before outputting the package in an organized fashion at the output conveyor system 1622 via the second access portals 1610, 1614, and 1618.

In this example, the PRS 1602, 1604, and 1606 may implement varying standard tray sizes, with each PRS optimally accommodating different package sizes. In this example, the PRSR system 1600 may also include a bypass conveyor 1624 that physically connects the input conveyor system 1622 to the output conveyor system 1624.

As an example of operation, if the output conveyor system 1622 is utilized to sort the packages for different vehicles (not shown) that are physically attached to the output conveyor system 1622, the PRSR system 1600 may organize the packages that are input into the PRSR system 1600, via the input conveyor 1620, into sets of packages that are organized to load specific packages into specific vehicles of the different vehicles. As a result, the PRSR system 1600 allows the different vehicles to be loaded with packages to optimize delivery vehicle travel routes, and to minimize the extent to which a delivery driver may need to search within a vehicle for parcels at each stop. Moreover, packages that are part of split shipments may be flexible optimized so that the related split shipments may be consolidated and loaded into fewer delivery vehicles.

FIG. 16B provides a top plan view of another embodiment of an APB 1650 implemented from a matrix of storage modules. In particular, three PRS 1660, 1670, 1680 are arranged in a parallel implementation. Each PRS 1660, 1670, 1680 includes input portals 1661, 1671, 1681 respectively centered along one side, and output portals 1662, 1672, 1682 centered on an opposite side, analogous to the arrangement of APB 100 in FIGS. 1A-3. Master input conveyor 1652 conveys parcels to per-module input conveyors 1663, 1673 and 1683. Per-module output conveyors 1664, 1674, 1684 feed parcels onto master output conveyor 1654 for output from APB 1650. In various applications, parallel PRS 1660, 1670, 1680 may be utilized for various combinations of increased storage capacity, increased package throughput, and handling of packages of various sizing.

Because PRS 1660, 1670, 1680 include side portals and lack internal conveyors, the amount of storage space per PRS may be maximized. However, as illustrated in FIG. 16B, additional spacing is required between PRS for input conveyors 1663, 1673, 1683 and output conveyors 1664, 1674, 1684, therefore reducing the overall parcel storage density of APB 1650. By contrast, the arrangement of FIG. 16A with end portals and an internal conveyor within each storage module may permit storage modules to be placed side-by-side against one another to minimize overall space utilization of the APB, at the expense of some storage area consumed by the internal conveyors. Various arrangements and configurations may be selected to optimize various factors based on design goals for any given installation.

Further, the disclosure comprises embodiments according to the following clauses.

Clause A. A pickup and receiving station (PRS) for an automated parcel buffer (APB). The PRS comprises: a plurality of shelves arranged as a first two-dimensional (2D) shelving matrix along and adjacent to a central corridor, and a second 2D shelving matrix along and adjacent to a side of the central corridor opposite the first 2D shelving matrix, wherein each shelf of the 2D shelving matrices is configured for engagement and support of the package tray to store the package tray; a 2D gantry oriented along the central corridor and adjacent to the first and second 2D shelving matrices; an end-of-arm tool (EOAT) supported by the 2D gantry, the EOAT selectively engaging and disengaging from a package tray, and moving the package tray between a central position, a first offset position extended in a first direction that is perpendicular to the 2D gantry, and a second offset position extended in a second direction that is perpendicular to the 2D gantry and is in an opposite direction to the first direction; a first access portal for receiving a package from outside of the PRS via conveyor, the first access portal positioned proximate the 2D gantry such that the EOAT can extend the package tray towards the first access portal for placement of the package on the package tray; and a second access portal for ejecting a package from the PRS onto an output conveyor, the second access portal positioned proximate the 2D gantry such that the EOAT can eject the package into the second access portal.

Clause B. The PRS of clause A, wherein each shelf of the plurality of shelves includes at least two shelving rails that are configured for the engagement and support of the package tray.

Clause C. The PRS of clause B, wherein the plurality of shelves includes a plurality of shelving rails organized into pairs of shelving rails such that each shelf may have a varying height based on which pair of shelving rails is used.

Clause D. The PRS of clause A, wherein the first access portal is located in a first side of the PRS at approximately a middle position of a length of the PRS; and the second access portal is located in a second side of the PRS that is opposite the first side, approximately at a middle position of the length of the PRS.

Clause E. The PRS of clause D, wherein the access portals each include a conveyor section.

Clause F. The PRS of clause A, wherein the first access portal is positioned in a direction that is parallel to the 2D gantry and is located at a first end of the PRS; and the second access portal is positioned in a direction that is parallel to the 2D gantry and is located at a second end of the PRS opposite the first end.

Clause G. The PRS of clause F, wherein the first access portal and the second access portal are each located proximate a centerline of the PRS.

Clause H. The PRS of clause F, further including an internal conveyor, wherein the internal conveyor extends parallel to the 2D gantry from the first access portal to the second access portal, and the EOAT extends the package tray towards the access portal by extending the package tray towards the internal conveyor for placement of the package on the package tray.

Clause I. The PRS of clause H, wherein the internal conveyor runs through an area within said plurality of shelves, adjacent to the central corridor.

Clause J. The PRS of clause I, wherein the plurality of shelves includes a shelving section located above the internal conveyor and a shelving section located below the internal conveyor.

Clause K. The PRS of clause A, wherein the EOAT includes a mounting point configured to be moveably attached to the 2D gantry; a linear actuator physically attached to the mounting point; a plate physically attached to the mounting point; a plurality of friction rollers physically attached to the plate; and a plurality of drive wheels physically attached to the plate; wherein the plurality of friction rollers is configured to selectively engage and disengage from the package tray, wherein the linear actuator is configured to move the package tray between the central position, the first position extended in the first direction, and the second position extended in the second direction, wherein the package tray is punctuated with cutouts that allow passage of the plurality of drive wheels, wherein the plurality of drive wheels are configured to either rise or lower through the cutouts, wherein the drive wheels are physically in contact with a bottom surface of the package when the plurality of drive wheels are raised, move the package on a portion of the package tray onto or off the package tray, position the package onto a desired position on the package tray, when the plurality of wheels are turning, and allow the package to rest on a top surface of the package tray when the plurality of drive wheels are lowered.

Clause L. The PRS of clause K, wherein the EOAT further includes a plurality of undriven support rollers for supporting a bottom of the package tray.

Clause M. The PRS of clause K, wherein the EOAT further includes a photoelectric sensor for detecting a notch on the package tray, wherein the detection of the notch provides a feedback for a drive system that drives the plurality of friction rollers.

Clause N. An automated parcel handling system comprising: a plurality of storage modules, each storage module comprising: a central corridor extending along a length of the module; a 2D gantry oriented along the central corridor; an end-of-arm tool (EOAT) supported by the 2D gantry, the EOAT selectively engaging and disengaging from a package tray, and moving the package tray between: a central position within the central corridor, a first offset position extended in a first direction that is perpendicular to the 2D gantry, and a second offset position extended in a second direction that is perpendicular to the 2D gantry and is in an opposite direction to the first direction; shelving matrices on each side of, and adjacent to, the central corridor, each shelving matrix comprising a plurality of shelving rail pairs into which a tray can be inserted or removed by the EOAT; and an intake access portal for receiving a package from outside of the storage module, the intake access portal positioned proximate the 2D gantry such that the EOAT extends the package tray towards the intake access portal for placement of the package on the package tray; and an outlet access portal for removing a package from the storage module, the outlet access portal positioned proximate the 2D gantry such that the EOAT can eject the package into the outlet access portal; and a plurality of conveyors interconnecting the plurality of storage modules access portals.

Clause O. The automated parcel handling system of clause N, in which two or more of said plurality of storage modules are configured for different size package trays.

Clause P. The automated parcel handling system of clause N, in which intake access portal and outlet access portal are located at opposite ends of a storage module; and wherein the storage modules are positioned adjacent to one another.

Clause Q. The automated parcel handling system of clause P, in which one or more of the storage modules comprise an internal conveyor extending within the storage module from the intake access portal to outlet access portal through an area adjacent to the central corridor.

Clause R. The automated parcel handling system of clause N, in which said storage modules are interconnected by said plurality of conveyors in an at least partly parallel arrangement, with an intake conveyor feeding intake access portals of two or more storage modules, and an outlet conveyor receiving packages from outlet access portals of two or more storage modules.

Clause S. The automated parcel handling system of clause N, in which said storage modules are interconnected by said plurality of conveyors in an at least partly serial arrangement, with an intermediary conveyor directing packages from an outlet portal of a first storage module to an intake access portal of a second storage module.

Clause T. The automated parcel handling system of clause N, in which the plurality of conveyors comprises a master input conveyor feeding packages to said plurality of storage modules, and a master output conveyor outputting packages from the plurality of storage modules.

While certain embodiments described herein utilize a tray having a relatively flat bottom surface, open above it, for supporting an item being handled, it is contemplated and understood that in other embodiments, a tray may include additional structure for supporting and/or containing items being stored and transported. For example, a tray may form an enclosed or contained area, such as via the inclusion of side surfaces and a top surface. Such closed container-based trays may be particularly beneficial in certain applications, such as transporting multiple parcels in a single tray or collections of loose items. An enclosed tray structure may also be beneficial, for example, in transporting groceries or ready-to-eat food items that may impact automation equipment or other parcels through release of aromas, heat or steam.

While certain embodiments of the invention have been described herein in detail for purposes of clarity and understanding, the foregoing description and FIGs. merely explain and illustrate the present invention and the present invention is not limited thereto. It will be appreciated that those skilled in the art, having the present disclosure before them, will be able to make modifications and variations to that disclosed herein without departing from the scope of any appended claims.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as an example implementations of such techniques.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Furthermore, the description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

It will also be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. A pickup and receiving station (PRS) for an automated parcel buffer (APB), wherein the PRS comprising:
a plurality of shelves arranged as a first two-dimensional (2D) shelving matrix along and adjacent to a central corridor, and a second 2D shelving matrix along and adjacent to a side of the central corridor opposite the first 2D shelving matrix, wherein each shelf of the 2D shelving matrices is configured for engagement and support of the package tray to store the package tray;
a 2D gantry oriented along the central corridor and adjacent to the first and second 2D shelving matrices;
an end-of-arm tool (EOAT) supported by the 2D gantry, the EOAT selectively engaging and disengaging from a package tray, and moving the package tray between
a central position,
a first offset position extended in a first direction that is perpendicular to the 2D gantry, and
a second offset position extended in a second direction that is perpendicular to the 2D gantry and is in an opposite direction to the first direction;
a first access portal for receiving a package from outside of the PRS via conveyor, the first access portal positioned proximate the 2D gantry such that the EOAT can extend the package tray towards the first access portal for placement of the package on the package tray; and
a second access portal for ejecting a package from the PRS onto an output conveyor, the second access portal positioned proximate the 2D gantry such that the EOAT can eject the package into the second access portal.

2. The PRS of claim 1, wherein each shelf of the plurality of shelves includes at least two shelving rails that are configured for the engagement and support of the package tray.

3. The PRS of claim 2, wherein the plurality of shelves includes a plurality of shelving rails organized into pairs of shelving rails such that each shelf may have a varying height based on which pair of shelving rails is used.

4. The PRS of claim 1, wherein the first access portal is located in a first side of the PRS at approximately a middle position of a length of the PRS; and the second access portal is located in a second side of the PRS that is opposite the first side, approximately at a middle position of the length of the PRS.

5. The PRS of claim 4, wherein the access portals each include a conveyor section.

6. The PRS of claim 1, wherein the first access portal is positioned in a direction that is parallel to the 2D gantry and is located at a first end of the PRS; and the second access portal is positioned in a direction that is parallel to the 2D gantry and is located at a second end of the PRS opposite the first end.

7. The PRS of claim 6, wherein the first access portal and the second access portal are each located proximate a centerline of the PRS.

8. The PRS of claim 6, further including an internal conveyor, wherein
the internal conveyor extends parallel to the 2D gantry from the first access portal to the second access portal, and
the EOAT extends the package tray towards the access portal by extending the package tray towards the internal conveyor for placement of the package on the package tray.

9. The PRS of claim 8, wherein the internal conveyor runs through an area within said plurality of shelves, adjacent to the central corridor.

10. The PRS of claim 9, wherein the plurality of shelves includes a shelving section located above the internal conveyor and a shelving section located below the internal conveyor.

11. The PRS of claim 1, wherein the EOAT includes:
a mounting point configured to be moveably attached to the 2D gantry;
a linear actuator physically attached to the mounting point;
a plate physically attached to the mounting point;
a plurality of friction rollers physically attached to the plate; and
a plurality of drive wheels physically attached to the plate;
wherein the plurality of friction rollers is configured to selectively engage and disengage from the package tray,
wherein the linear actuator is configured to move the package tray between the central position, the first position extended in the first direction, and the second position extended in the second direction,
wherein the package tray is punctuated with cutouts that allow passage of the plurality of drive wheels,
wherein the plurality of drive wheels are configured to
either rise or lower through the cutouts, wherein the drive wheels are physically in contact with a bottom surface of the package when the plurality of drive wheels are raised,
move the package on a portion of the package tray onto or off the package tray,
position the package onto a desired position on the package tray, when the plurality of wheels are turning, and
allow the package to rest on a top surface of the package tray when the plurality of drive wheels are lowered.

12. The PRS of claim 11, wherein the EOAT further includes a plurality of undriven support rollers for supporting a bottom of the package tray.

13. The PRS of claim 11, wherein the EOAT further includes a photoelectric sensor for detecting a notch on the package tray, wherein the detection of the notch provides a feedback for a drive system that drives the plurality of friction rollers.

14. An automated parcel handling system comprising:
a plurality of storage modules, each storage module comprising:
a central corridor extending along a length of the module;
a 2D gantry oriented along the central corridor;
an end-of-arm tool (EOAT) supported by the 2D gantry, the EOAT selectively engaging and disengaging from a package tray, and moving the package tray between:
a central position within the central corridor, a first offset position extended in a first direction that is perpendicular to the 2D gantry, and a second offset position extended in a second direction that is perpendicular to the 2D gantry and is in an opposite direction to the first direction;
shelving matrices on each side of, and adjacent to, the central corridor, each shelving matrix comprising a plurality of shelving rail pairs into which a tray can be inserted or removed by the EOAT;
an intake access portal for receiving a package from outside of the storage module, the intake access portal positioned proximate the 2D gantry such that the EOAT extends the package tray towards the intake access portal for placement of the package on the package tray; and
an outlet access portal for removing a package from the storage module, the outlet access portal positioned proximate the 2D gantry such that the EOAT can eject the package into the outlet access portal; and
a plurality of conveyors interconnecting the plurality of storage modules access portals.

15. The automated parcel handling system of claim 14, in which two or more of said plurality of storage modules are configured for different size package trays.

16. The automated parcel handling system of claim 14, in which intake access portal and outlet access portal are located at opposite ends of a storage module; and wherein the storage modules are positioned adjacent to one another.

17. The automated parcel handling system of claim 16, in which one or more of the storage modules comprise an internal conveyor extending within the storage module from the intake access portal to outlet access portal through an area adjacent to the central corridor.

18. The automated parcel handling system of claim 14, in which said storage modules are interconnected by said plurality of conveyors in an at least partly parallel arrangement, with an intake conveyor feeding intake access portals of two or more storage modules, and an outlet conveyor receiving packages from outlet access portals of two or more storage modules.

19. The automated parcel handling system of claim 14, in which said storage modules are interconnected by said plurality of conveyors in an at least partly serial arrangement, with an intermediary conveyor directing packages from an outlet portal of a first storage module to an intake access portal of a second storage module.

20. The automated parcel handling system of claim 14, in which the plurality of conveyors comprises a master input conveyor feeding packages to said plurality of storage modules, and a master output conveyor outputting packages from the plurality of storage modules.
